(19) United States
(12) Patent Application Publication
(10) Pub. No.: US 2008/0088791 A1
(43) Pub. Date: Apr. 17, 2008

(54) Auxiliary Eyewear Assembly With Micromagnetic Attachment

(76) Inventor: Greg Smith, Plano, TX (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/667,796

(22) PCT Filed: Nov. 14, 2005
(86) PCT No.: PCT/US05/41201

§ 371 Date: Dec. 6, 2007

Related U.S. Application Data
(60) Provisional application No. 60/627,451, filed on Nov. 12, 2004.
(60) Provisional application No. 60/656,614, filed on Feb. 25, 2005.
(60) Provisional application No. 60/687,477, filed on Jun. 3, 2005.
(60) Provisional application No. 60/706,685, filed on Aug. 9, 2005.
(60) Provisional application No. 60/706,797, filed on Aug. 9, 2005.
(60) Provisional application No. 60/726,440, filed on Oct. 13, 2005.

(51) Int. Cl. G02C 9/00

(52) U.S. Cl. 351/57

(57) ABSTRACT

The present invention relates to eyewear, and in particular, to an eyewear assembly that incorporates an auxiliary lens assembly for removable attachment to a primary lens assembly. Still more specifically, the present invention relates to an auxiliary lens assembly configured for micromagnetic attachment to a primary lens assembly.

### TECHNICAL FIELD OF INVENTION

The present invention relates to eyewear, and more particularly, to an eyewear assembly that incorporates an auxiliary lens assembly for removable attachment to a primary lens assembly by means of magnetic attraction.

### BACKGROUND OF THE INVENTION

It has long been desirable to have a removable auxiliary lens assembly attached to eyeglasses. Professional baseball players have used “flip-up” auxiliary lenses for more than four decades to protect their eyes from the sun, yet to allow them unrestricted vision in the event the ball was hit in their vicinity.

U.S. Pat. No. 3,252,747 to Robins discloses an eyewear system specifically designed for persons who are far sighted. The device includes an auxiliary lens assembly that may be rotated about the horizontal axis and yet remain attached to a primary lens assembly so as to locate the lenses at the proper distance to the eyes when the device is lowered into place. A significant disadvantage of this design is that it is unattractive, overly complicated, and cannot be easily segregated from the primary eyeglass frame, and does accommodate anyone other than farsighted individuals.

U.S. Pat. No. 3,238,005 to Petitto discloses the combination of a primary lens assembly and auxiliary lens assembly. The auxiliary assembly has flexible side wall projections with openings that can be assembled onto lugs (pins) extending perpendicularly from the sides of the primary lens assembly, allowing the auxiliary lens assembly to be pivoted upwards, and back downwards. Leaf springs mounted on the auxiliary lens assembly engage surfaces of the primary lens assembly to urge the auxiliary assembly into position. A significant disadvantage of this design is that it is unattractive, overly complicated, and resists easy and immediate removal of the auxiliary lens assembly from the primary lens assembly.

To overcome the deficiencies of mechanically attached (eg. clipped on) devices for holding an auxiliary lens assembly to a primary lens assembly numerous attempts have been made to magnetically attach an auxiliary lens assembly to a primary lens assembly.

U.S. Pat. No. 4,070,103 to Meeker discloses eyeglasses having attachable pairs of lens rim covers. The lens rims are made of magnetizable material. A magnetic strip is provided in a groove on the inside surface of the lens rim cover. When the lens rim cover is placed on the rim, it is magnetically attracted and therefore magnetically engage said rim. A disadvantage of this invention is that the magnetic band made of conventional magnet materials is bulky and heavy, and the entire assembly is overly complicated. Also, band-like magnetic materials must be ductile enough to prevent breakage, and thus the compositions of the magnetic materials suitable for use are limited.

U.S. Pat. No. 5,416,537 to Sadler discloses a primary lens assembly having a first magnetic member attached vertically to the front surface of the primary lens assembly, and a second magnetic member attached in a corresponding position on the back surface on an auxiliary lens assembly. The magnetic members are arranged for engagement to secure the auxiliary lens assembly to the primary lens assembly.

U.S. Pat. No. 5,568,207 to Chao also discloses a magnetically adhered auxiliary lens assembly, with the additional feature of arms extending from the side portions of the auxiliary lens assembly, over magnet retaining projections and extensions of the primary lens assembly. The arms engage with, and are supported on, the primary lens assembly extensions to prevent disengagement of the auxiliary lens assembly upon downward movement of the auxiliary lens assembly relative to the primary lens assembly.

Many of the developments in auxiliary eyewear systems such as those described above rely on a combination of both mechanical and magnetic engagement. The magnetic engagement elements are not in and of themselves generally sufficient to retain an auxiliary lens assembly attached to a primary lens assembly during normal use.

U.S. Pat. No. 6,089,708 to Ku discloses a connecting member having spaced connecting plates for attachment to the bridge portion of a primary lens assembly. The connecting plates have magnetic members that act cooperatively with a complimentary magnetic member inserted in a hole on the bridge portion. The front of the connecting part has an open communication to a polygonal shaped holding room. The auxiliary lens assembly has connecting rods extending above the bridge portion, and supporting an intermediate portion having a polygonal shape, receivable and rotatable in the holding room. A significant disadvantage of this design is that it is unattractive, overly complicated, and does not readily facilitate easy and immediate removal of the auxiliary lens assembly when desired.

U.S. Pat. No. 6,474,811 to Liu discloses a spectacle frame combination having an auxiliary lens assembly magnetically and pivotally attached to a primary lens assembly. The primary lens assembly has an integral magnetic portion generating a magnetic field on both an inner and an outer surface of a temple member. The frame of the auxiliary lens assembly may be attached to either the inner or outer surface of the primary lens assembly by the cooperation of magnetic end portions of the auxiliary lens assembly with complementary magnetic portions of the frame of the primary lens assembly. A significant disadvantage of this design is that it is unstable and relying on tenuous repositioning to engage, and magnetic forces to engage the auxiliary lens assembly to the primary lens assembly. A mechanical engagement member is also present on the bridge section of the auxiliary lens assembly to supplement the magnetic engagement. In this disclosure, magnetic portions are needed on both of the frames of the primary and auxiliary lens assemblies. Since there is two positions in which the frame of the auxiliary lens assembly can be magnetically engaged to the frame of the primary lens assembly, there exists a possibility that the corresponding magnetics will not be correctly aligned, leading to an accelerated demagnetization of the magnetic portions.

U.S. Pat. No. 6,301,953 to Xiao discloses an auxiliary lens assembly having pivots mounted above the lenses and attached by long, L-shaped shelter arms. The shelter arms are attached to supporting arms having magnet holding housings attached at their ends. Magnets are inset in the housings for engagement over rearwardly protruding rim lockers. One disadvantage of this design is that it is fails to limit the rotation of the auxiliary lens assembly. Another disadvantage is that it is aesthetically unappealing, due in part to the long shelter arm requirement. Another disadvantage is that it relies on a bridge magnet or bridge hook for stability, requiring that extra components and/or a larger bridge. Another disadvantage is that the device relies on magnetic force to pull the magnetic housing forward, over a rearward protruding lens locker, requiring the user push the frame of the auxiliary lense assembly rearward, into the primary lens assembly to disengage the magnetic housing from the lens locker. Another disadvantage is that the device is complex and expensive to manufacture.

Each of the above designs requires the lenses of the assemblies to be limited in width, so as to accommodate the magnets and mechanical engaging apparatus on the outside of the lenses. As a result, peripheral vision through the lens is limited. This gives rise to both convenience and safety issues. For example, a nearsighted person trying to change lanes on a freeway is forced to rotate their head significantly further around to allow alignment of their eye through their lens in the direction of the vehicle blind spot. These processes increase the time required to affect the manoeuvre, and requires and increased time in which the direction in which the car is traveling at high speed is not visible.

The prior art magnets and mechanical engaging apparatus used to attach an auxiliary lens assembly to a primary lens assembly typically involve extensions on the frames of the primary lens assembly. The extensions must be large enough to accommodate magnets that are large enough to exert the necessary force to retain the auxiliary lens assembly in place attached to the primary lens assembly. Similarly, an auxiliary lens assembly may require extensions that, in one manner or another, protrude over the extensions of the frame of the primary lens assembly, that need to be aligned with said extensions and that include retainers for supporting auxiliary lens assembly magnets.

The resulting disadvantage is that the prior art design for combining primary and auxiliary lens assemblies involve delicate soldering of numerous extraneous parts which extend from the sides of the lens assemblies. The only purpose of the several extraneous parts is to support the magnets and/or mechanical engagement of the auxiliary frame assembly to the primary frame assembly.

U.S. Pat. No. 5,786,880 to Chao discloses an eyeglass frame combination including a primary frame and a secondary frame having one or more magnetizable members embedded within the frames prior to magnetizing the members. The magnetizable members are then electroplated, painted, and magnetized with a magnetizing machine, such as an electromagnetic machine. A disadvantage of this design is that the resulting eyeglass frame is relatively bulky and the discrete magnets made of conventional materials lack sufficient power and life to support the auxiliary lens assembly to the primary lens assembly.

U.S. Pat. No. 6,412,942 to McKenna and Smith discloses a heat-treated magnetic alloy frame configured to magnetically couple the auxiliary lens assembly to the primary lens assembly. Heat treating of a spinodal decomposition alloy magnetizes the alloy. A disadvantage of this design relates to the manufacturing costs and challenges associated with heat treating a thin metal frame.

U.S. Pat. No. 6,331,057 to Strube discloses a clip-on option for the auxiliary lens assembly in which the auxiliary lens assembly is held by cylindrical magnets, located in the auxiliary bridge region and the primary bridge region. One disadvantage of this design is the necessity to have large and bulky bridge regions on both the auxiliary lens assembly and the primary lens assembly.

The most widely and commonly used magnets today are Ceramic, also known as Ferrite, magnets. They are made of a composite of iron oxide and barium/strontium carbonate. Since these materials are readily available and cost less than other types of materials used in permanent magnets, Ceramic or Ferrite magnets are popular due to their lower cost. Ceramic magnets are often made using what is known by one skilled in the art as pressing and sintering processes. (include reference) Sintering is a method used for making objects from powder by increasing the molecular attraction exerted between particles as they are heated. They can also be made by a bonding process, where a bonding agent is added to their composition to be shaped afterwards. Ceramic or Ferrite magnets are brittle and can be produced in different grades.

For example, Ceramic 1 is an isotropic grade with equal magnetic properties in all directions. Ceramic grades 5 and 8 are anisotropic grades, these magnets being magnetized in the direction of pressing. The anisotropic method delivers the highest maximum energy product (BH)ₘₐₓ among Ceramic magnets at values up to approximately 4.0 MGOe (Mega Gauss Oersted, 1 MGOe=7,957 T·A/m=7,957 J/m³) (see StandardSpecifications for Permanent Magnet Materials, MMPA Standard No. 0100-00, hereinafter “MMPA Standard”). The energy product, B_{d}H_{d}, of a magnet indicates the energy that a magnetic material can supply to an external magnetic circuit. Ceramic magnets are widely used in magnetic eyewear assemblies for their low cost and relatively good resistance to corrosion. Ceramic magnets, however, have a low energy product. This latter characteristic is important in the field of magnetic eyewear assemblies as the primary function of magnets in this field is the magnetic coupling of lens assemblies. Therefore, the size, or volume, of Ceramic magnets needed for use in magnetic eyewear assemblies has to be considerable to achieve the desired strength of magnetic coupling. Furthermore, by using traditional Ceramic magnets, Alnico magnets (magnets made from Aluminium-Nickel-Cobalt alloys, delivering a maximum energy product values up to approximately 9.0 MGOe) or other magnets having a relatively low maximum energy product (BH)ₘₐₓ in magnetic eyewear assemblies, one is limited in the orientation these magnets can be placed within a primary lens assembly and/or an auxiliary lens assembly. There is often a need to add relatively large extraneous components to accommodate the relatively large magnets. Such a limitation is a direct consequence of the weaker energy product, hence strength, of the magnets. With the limited energy available to perform work, there is normally no other choice other than to dispose the magnets in an arrangement where the coupling is through the use of complementary poles of magnets affixed respectively to the primary lens assembly and the auxiliary lens assembly (the face of the magnets involved in the coupling always being either the North pole or the South pole and the coupling occurring in the North-South orientation). The strongest magnetic field of a permanent magnet is located at the poles, and when using relatively low energy product magnets, it is desirable, and often necessary, to use the maximal magnetic field possible to be able to achieve the desired engagement results. This is especially true when only one of the magnetic coupling elements is a permanent magnet providing a low energy product and the other complementary magnetic coupling element is made of a magnetically attractable material but not magnetized material, as is often the case in the magnetic eyewear systems. Accordingly, there remains a need to provide more compact and discrete magnetic means capable of providing a relatively high energy product for application to eyewear assemblies.

Another significant disadvantage of using conventional magnets in the magnetic eyewear industry is their relatively low intrinsic coercive force H_{ci}. The intrinsic coercive force H_{ci} of a of a material indicates its resistance to demagnetization. It is equal to the demagnetizing force which reduces the intrinsic induction in the material to zero after magnetizing to saturation; measured in oersteds. The intrinsic coercive force of conventional Ceramic magnets varies approximately from 2500 to 4800 oersteds and approximately from 480 to 2020 oersteds for conventional Alnico magnets. Although various factors can affect the demagnetization of magnets, under similar conditions, materials with a lower intrinsic coercive force demagnetize faster than materials with a higher intrinsic coercive force. This consideration is also important in the magnetic eyewear industry since eyewear devices usually have a useful life of several years.

Accordingly, there is a need to develop a design for combined lens with fewer extraneous parts as found in traditional designs, which encumber their appearance and limit design possibilities. There is also a need to provide with regard to eyewear systems a magnetic means which is of sufficient force to support the removable attachment of an auxiliary lens assembly to a primary lens assembly without necessarily a requirement for non-magnetic mechanical engagement, in order to simplify the structure and configuration of primary/auxiliary lens assemblies and provide for more lightweight constructions that are readily attachable without the need to manoeuvre extraneous components and/or extensions into engagement. There is also a need to provide such magnetic means that is not necessarily limited to ferromagnetic material that it also cost effective and that can support the objective of overall design simplification.

### SUMMARY OF THE INVENTION

One advantage of the present invention is that it provides a micromagnetic system for application to eyewear assemblies that is aesthetically appealing, that is smaller in size and that is light-weight, allowing for a greater variety of designing choices previously unavailable in known eyewear attachment systems and cost effective to produce. Another advantage of the present invention it is does not require mechanical interlocking engagements to prevent disassociation of the auxiliary lens assembly from the primary lens assembly under normal usage, although such components may optionally be incorporated. Other advantages of the present invention will become apparent from the following descriptions, taken in connection with the accompanying drawings, wherein, by way of illustration and example, an embodiment of the present invention is disclosed.

As referred to hereinabove and hereinafter, the expression “present invention” refers to one or more embodiments of the present invention which may or may not be claimed, and such references are not intended to limit the language of the claims, or to be used to construe the claims in a limiting manner.

In one aspect of the invention, there is provided an eyewear system comprising: a primary lens assembly; an auxiliary lens assembly; one or more pair of complementary mating areas disposed on said primary and auxiliary lens assemblies; and each of said one or more pair of complementary mating areas including one or more micromagnets associated with a first complementary mating area and a magnetically attractable material associated with a second complementary mating area; wherein said one or more micromagnets couple with said magnetically attractable material to removably affix said auxiliary lens assembly to said primary lens assembly.

In another aspect of the invention, an eyewear system comprising: a primary lens assembly comprising one or more primary lens mating areas; an auxiliary lens assembly comprising one or more auxiliary lens mating areas configured to align with said one or more primary lens mating areas; one or more micromagnets associated with one or more of said one or more mating areas; and a magnetically attractable material associated with one or more of said one or more mating areas and capable of coupling with said one or more micromagnets, wherein said one or more micromagnets couple with said magnetically attractable material when said one or more auxiliary lens mating areas are in sufficient proximity and alignment with said one or more primary lens mating areas.

In accordance with another aspect of the invention, there is provided an auxiliary lens assembly comprising one or more micromagnets for coupling with a magnetically attractable material of a primary lens assembly.

In accordance with further aspect of the invention, there is provided a primary lens assembly comprising one or more micromagnets for coupling with a magnetically attractable material of an auxiliary lens assembly.

### BRIEF DESCRIPTION OF THE DRAWINGS

The objects and features of the invention will become more readily understood from the following detailed description, claims and accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of an auxiliary lens assembly attached to a primary lens assembly in accordance with an embodiment of the present invention.

FIG. 2 is an isometric breakout view illustrating the auxiliary lens assembly being coupled to the primary lens assembly.

FIG. 3 is a front view of an auxiliary lens assembly attached to a primary lens assembly in accordance with an embodiment of the present invention.

FIG. 4 is a side view of the auxiliary lens assembly and primary lens assembly illustrated in FIG. 3.

FIG. 5 is a rear break-out view of the auxiliary lens assembly of the present invention, illustrating slots and micromagnets located in the back of the auxiliary frame.

FIG. 6 is a side-sectional view as indicated in FIG. 3, and illustrates the relationship between the primary frame and auxiliary frames when the primary and auxiliary lens assemblies are attached.

FIG. 6A is a rear break-out view of an alternative embodiment of the auxiliary lens assembly of the present invention, illustrating slots and micro-magnets located in the back of the auxiliary lens assembly as well as the groove in the auxiliary bridge.

FIG. 6B is a cross section of the bridges of the primary and auxiliary lens assemblies

FIG. 6C is an isometric view of an auxiliary lens assembly attached to a primary lens assembly in accordance with an embodiment of the present invention, which illustrates the bridge of the primary lens assembly interacting with the complementary groove in the auxiliary lens assembly.

FIG. 6D is an isometric breakout view of another embodiment of the present invention, illustrating the auxiliary lens assembly having grooves in the side of the back of the auxiliary lens assembly that interact with the temple pieces of the primary lens assembly.

FIG. 6E is a rear break-out view of the auxiliary lens assembly of an embodiment of the present invention, illustrating slots and micro-magnets as well as grooves located in the back of the auxiliary lens assembly.

FIG. 7 is an isometric breakout view of another embodiment of the present invention, illustrating the auxiliary lens assembly having a shelf extending out of the back of the upper portion of the auxiliary frame.

FIG. 7A is an isometric rear view of the primary and auxiliary lens assemblies illustrating the auxiliary shelf with a retaining tab according to an embodiment of the present invention.

FIG. 8 is a rear break-out view of the auxiliary lens assembly of the present invention, illustrating a slot and micromagnet located in the shelf of the auxiliary frame.

FIG. 9 is a side-sectional view (as indicated in FIG. 3 in another embodiment), illustrating the relationship between the primary frame, auxiliary frame, and shelf, when the primary and auxiliary lens assemblies are attached.

FIG. 10 is an isometric breakout view of another embodiment of the present invention, illustrating the auxiliary lens assembly having a shelf extending out of the majority of the perimeter of the back of the auxiliary frame, and having a relief for accommodation of the extension of the primary frame of the primary lens assembly.

FIG. 11 is a rear break-out view of the auxiliary lens assembly of the present invention, illustrating slots and micromagnets located in the back of the auxiliary frame.

FIG. 12 is a side-sectional view illustrating the relationship between the primary frame, auxiliary frame, and perimeter surrounding shelf, when the primary and auxiliary lens assemblies are attached.

FIG. 12A is a front view of the auxiliary lens assembly in accordance with an embodiment of the present invention.

FIG. 12B is a side view of the auxiliary lens assembly, illustrating the auxiliary shelf, in accordance with an embodiment of the present invention.

FIG. 12C is a top view of the auxiliary lens assembly illustrating an auxiliary shelf and the placement of micromagnets on the underside of said shelf according to an embodiment of the present invention.

FIG. 13 is a rear break-out view of an alternative embodiment of the auxiliary lens assembly of the present invention, illustrating slots and micromagnets located in the back of the auxiliary frame, in which micromagnets are paired together with common poles located matched in close proximity.

FIG. 14 is a sectional break-out of the embodiment disclosed in FIG. 13.

FIG. 15 is a rear close-up view of the embodiment disclosed in FIG. 13, illustrating slots and micro-magnets located in the back of the auxiliary lens assembly, in which micro-magnets are paired together with common poles located matched in close proximity.

FIG. 16 is an isometric view of a primary and auxiliary lens assembly according to an embodiment of the present invention.

FIG. 17 is an isometric view of the auxiliary lens assembly, mated with the primary lens assembly, according to an embodiment of the present invention.

FIG. 18 is a top and front view of the primary lens assembly, illustrating the placement of the mating surface, according to an embodiment of the present invention.

FIG. 19 is a rear view of the primary frame, illustrating the placement of the mating surface, according to an embodiment of the present invention.

FIG. 19A is a rear view of the auxiliary lens assembly, according to an embodiment of the present invention.

FIG. 20 is a front view of the auxiliary lens assembly, according to another embodiment of the present invention.

FIG. 21 is a side view of the auxiliary frame, illustrating the shelf, according to an embodiment of the present invention.

FIG. 22 is a top view of the auxiliary lens assembly depicted in FIG. 20.

FIG. 23 is a rear view of the auxiliary lens assembly, illustrating the auxiliary frame, auxiliary shelf and retaining tab, according to an embodiment of the present invention.

FIG. 24 is a side-sectional view illustrating the auxiliary frame, and shelf with retaining tab, according to an embodiment of the present invention.

FIG. 25 is a rear view of the auxiliary lens assembly illustrating the shelf with retaining tab according to an embodiment of the present invention.

FIG. 26 is an isometric view of an auxiliary lens assembly coupled to a primary lens assembly in accordance with an embodiment of the present invention.

FIG. 27 is an exploded isometric view illustrating the auxiliary lens assembly uncoupled from the primary lens assembly of FIG. 26.

FIG. 28 is a side cross-sectional view illustrating the auxiliary lens assembly coupled to a primary lens assembly of FIG. 26.

FIG. 29 is an isometric view of the auxiliary lens assembly of FIG. 26.

FIG. 30 is an isometric view of an auxiliary lens assembly and a primary lens assembly in accordance with an embodiment of the present invention.

FIG. 31 is a front break-out view illustrating the auxiliary lens assembly according to an embodiment of the present invention.

FIG. 32 is a front break-out view illustrating the primary lens assembly according to an embodiment of the present invention.

FIG. 33 is a side view of an auxiliary lens assembly attached to a primary lens assembly in accordance with an embodiment of the present invention.

FIG. 34 is a top view of an arm of the primary lens assembly in accordance with an embodiment of the present invention.

FIG. 35 is a top view of a bushing having an attached micromagnet in accordance with an embodiment of the present invention.

FIG. 36 is a top view of a bushing having an embedded micromagnet in accordance with another embodiment of the present invention.

FIG. 37 is a top view of a levered arm of a primary lens assembly having a hinged portion, in accordance with another embodiment of the present invention.

FIG. 38 is a top view of an arm having an alternative bushing configuration in accordance with another embodiment of the present invention.

FIG. 39 is an top view of an alternative bushing configuration in accordance with another embodiment of the present invention.

FIG. 40 is a side view of an alternative configuration of an auxiliary lens assembly attached to a primary lens assembly in accordance with an embodiment of the present invention.

FIG. 41 is a top view of an alternative bushing configuration having a micromagnet embedded in a side in accordance with an embodiment of the present invention.

FIG. 42 is a rear breakout view of a primary lens assembly utilizing a bushing configuration having a micromagnet embedded in a side in accordance with an embodiment of the present invention.

FIG. 43 is a rear breakout view of an auxiliary lens assembly configured to couple to a bushing having a micromagnet embedded in a side in accordance with an embodiment of the present invention.

FIG. 44 is a rear breakout view of the alternative configuration of an auxiliary lens assembly attached to a primary lens assembly in accordance with an embodiment of the present invention.

FIG. 45 is a rear breakout view of a bushing having a micromagnet embedded in a side coupling to the auxiliary magnetic lens assembly in accordance with an embodiment of the present invention.

FIG. 46 is an isometric view of an auxiliary lens assembly coupled to a primary lens assembly in accordance with an embodiment of the present invention.

FIG. 47 is an isometric view illustrating the primary lens assembly according to the embodiment of the present invention illustrated in FIG. 46.

FIG. 48 is an isometric view illustrating the auxiliary lens assembly according to the embodiment of the present invention illustrated in FIG. 46.

FIG. 49 is a top view of an auxiliary lens assembly attached to a primary lens assembly according to the embodiment of the present invention illustrated in FIG. 46.

FIG. 50 is a side view of auxiliary lens assembly attached to a primary lens assembly according to the embodiment of the present invention illustrated in FIG. 46.

FIG. 51 is a rear breakout view of the auxiliary lens assembly according to the embodiment of the present invention illustrated in FIG. 46.

FIG. 52 is a rear breakout view of an alternative embodiment of the auxiliary lens assembly of according to the embodiment of the present invention illustrated in FIG. 46.

FIG. 53 is a rear breakout view of an alternative embodiment employing an interference fit of the auxiliary lens assembly according to an embodiment of the present invention.

FIG. 54 is a side view of auxiliary lens assembly attached to a primary lens assembly according to an embodiment of the present invention.

FIG. 55 is a rear breakout view of the auxiliary lens assembly according to the embodiment of the present invention illustrated in FIG. 54.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

### DEFINITIONS

The term “magnetically attractable material” is used to define any material which can exhibit a magnetization in the presence of a magnetic field. It includes any ferromagnetic and ferrimagnetic materials, such as, but not limited to, rare earth magnets (e.g. micromagnets as described herein), steels, stainless steels, Alnico magnets, Ceramic magnets, any transition metal-metalloid alloy, made from combinations of metals such as Fe, Co, or Ni and a metalloid component such as B, C, Si, P, or Al, any soft or hard magnetic material, etc. It is to be understood that magnetically attractable material in its broadest sense may also comprise any suitable combination of ferromagnetic and ferrimagnetic materials and configurations of such materials. As used herein magnetic material includes materials which can be magnetized in order to become magnetically attractable material. Micromagnetic material refers to a form or magnetizable materials that can be magnetized to provide one or more micromagnets.

The term “mating area” is used to define a first area of any size on a lens assembly designed to mate with a second complementary area on another lens assembly to allow the two lens assemblies to be coupled through magnetic attraction/force. A primary lens assembly and auxiliary lens assembly are an example of such a pair of lens assemblies which may have complementary mating areas. A mating area can comprise magnetically attractable material and/or one or more micromagnets. It will also be appreciated that complementary mating areas need not be equivalent in area but that the term “complementary” used in reference to a pair of mating areas denotes sub-areas in each mating area that serves as contacts points where two lens assemblies are brought in a desired alignment for removal attachment. In this manner, complementary mating areas may be said to be configured to align with one another through one or more contact points. Contact points do not necessarily require physical contact for the two lens assemblies to be coupled.

The terms “engage”, “couple”, “attach” and “affix,” and all derivations or variations thereof, as used herein and unless otherwise qualified, refer to the coming together of elements held by a magnetic attraction/force. This may be facilitated, for example, by magnetically attractable materials associated with a first complementary mating area and a second complementary mating area, it being understood that said complementary mating areas are placed or disposed on primary and auxiliary lens assemblies. Therefore, if a primary lens assembly is brought into suitable alignment and proximity with an auxiliary lens assembly the magnetically attractable materials of complementary mating areas will provide for the magnetic attachment of the lens assemblies. It will also be appreciated by one skilled in the art that the coupling of elements which facilitate the attachment of an auxiliary lens assembly to a primary lens assembly is removable in the sense that the two lens assemblies will remain attached during normal usage, but may at the will of the user be readily detached manually under circumstances in which it is desirable to do so.

Spatial references: Unless otherwise specified, the terms “right” and “left” as used herein are referenced from the perspective of a person wearing the primary and auxiliary lens assemblies. The references are intended to aide in the description of the device, and are not intended to be limiting, since embodiments of the device are generally symmetric. The term “front” of a lens assembly faces away from the person wearing the lens assembly. The term “back” of a lens assembly is proximate to the face of the person wearing the primary lens assembly.

Unless defined otherwise, all technical and scientific terms used herein have the same meaning as commonly understood by one of ordinary skill in the art to which this invention belongs.

Primary Lens Assembly

The primary lens assembly according to the invention may include any one of a variety of constructions and configurations suitable for coupling with an auxiliary lens assembly, by means of magnetic attraction in which one or more micromagnets is involved. One skilled in the art would appreciate that a portion or all of the primary lens assembly (with or without lenses) may comprise a magnetically attractable material to facilitate attachment with an auxiliary lens assembly also comprising magnetically attractable material.

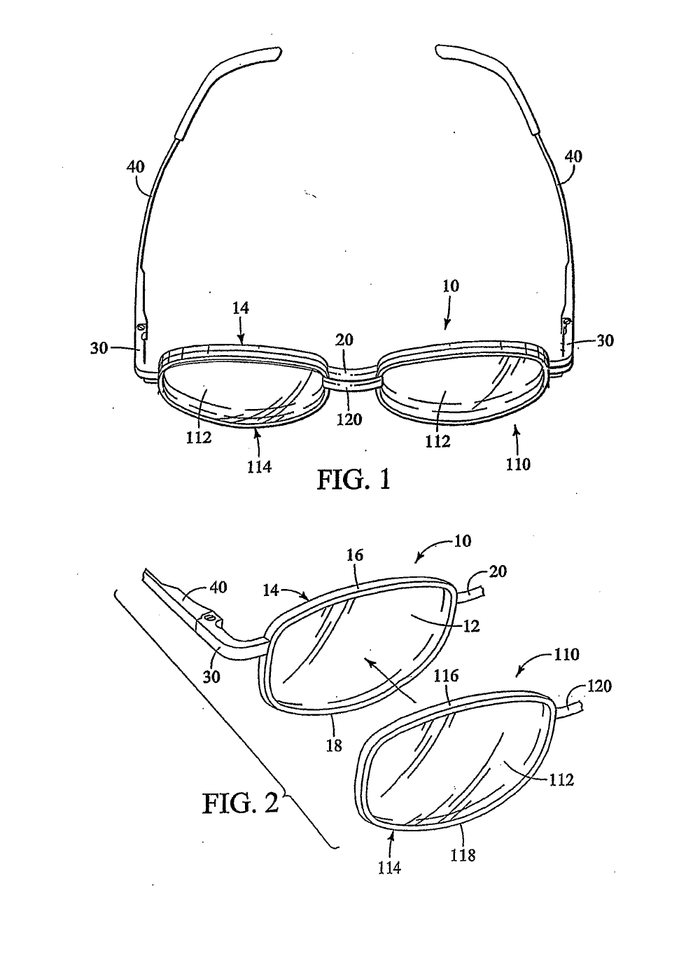

In one embodiment of the present invention as shown in FIG. 1, the primary lens assembly 10 comprises a primary frame, one or more mating areas, side extensions and arms. The side extensions project from the outer portions of the frame and extend generally rearwardly from the primary frame. An arm is pivotally connected to each of the side extensions for supporting the primary lens assembly on the head of the wearer. The primary frame 20 comprises two primary lens rims held in fixed relation to each other by a primary bridge. The primary lens assembly is designed to retain a pair of primary lenses in fixed relationship and has a top portion, bottom portion, outer portions, front and back. The top portion comprises the top of the bridge and the top each of the lens rims of the primary frame. The front of the primary frame faces away from the person wearing the primary lens assembly. The back of the primary frame is proximate to the face of the person wearing the primary lens assembly. The primary frame is either entirely or partially made of magnetically attractable material and may or may not comprise one or more micromagnets associated with a given mating area.

In accordance with another embodiment of the invention, the primary lens assembly is a frameless lens assembly as shown in FIGS. 30 and 31. In accordance with an alternative embodiment, the primary lens assembly is a partly frameless lens assembly (not shown) in which a frame portion may run, for example, along the top perimeter of the lenses and continuous with the bridge portion of the primary lens assembly. In accordance with yet another non-limiting embodiment of the invention, the primary lens assembly does not have side extensions.

In yet another embodiment of the invention, the primary lens assembly is designed to retain corrective lenses.

In still another embodiment of the invention, the primary lens assembly is designed to retain lenses which are light transmission reducing lenses, for example, a polarizing, absorbing, refracting, welding lenses, photochromatic, or reflecting lenses, or any combination thereof (i.e., sunglasses). The placement of light transmission reducing lenses into the frame of a primary lens assembly as opposed to an auxiliary lense assembly is an alternative embodiment contemplated to the more conventional placement of transmission reducing lenses in an auxiliary lens assembly as exemplified in numerous examples described herein.

In an embodiment of the present invention, the primary lens assembly is designed to retain lenses which are impact resistant safety lenses.

Auxiliary Lens Assembly

The auxiliary lens assembly according to the invention may include any one of a variety of constructions and configurations suitable for coupling with a primary lens assembly in which one or more micromagnets is involved. In one embodiment of the invention, the auxiliary lens assembly comprises a frame and one or more mating areas associated with said frame. The auxiliary frame comprises two auxiliary lens rims held in fixed relation to each other by an auxiliary bridge. The auxiliary lens assembly is designed to retain a pair of auxiliary lenses in fixed relationship and has a top portion, bottom portion, outer portions, front and back. The top portion comprises the top of the bridge and the top each of the lens rims of the auxiliary frame. The front of the auxiliary frame faces away from the person wearing the auxiliary lens assembly. The back of the auxiliary frame is proximate to the face of the person wearing the primary lens assembly. The auxiliary frame is either entirely or partially made of magnetically attractable material and may or may not comprise one or more micromagnets associated with a given mating area.

In accordance with another embodiment of the invention, the auxiliary lens assembly is a frameless lens assembly. In accordance with yet another embodiment of the invention, the auxiliary lens assembly is a partly frameless lens assembly in which a frame portion may run, for example, along the top perimeter of the lenses and continuous with the bridge portion of the auxiliary lens assembly.

The auxiliary lens assembly may be coupled to the primary lens assembly. In this manner, the person wearing the eyewear system has two lenses combining to alter the transmission of light to each eye.

In an embodiment of the invention, the auxiliary lens assembly is designed to retain lenses which are light transmission reducing lenses, for example, a polarizing, absorbing, refracting, welding lenses, photochromatic, or reflecting lenses, or any combination thereof (i.e., sunglasses).

In another embodiment of the invention, the auxiliary lens assembly is designed to retain corrective lenses.

In a further embodiment of the invention, the auxiliary lens assembly is designed to retain lenses which are impact resistant safety lenses.

In accordance with a still further embodiment of the invention the auxiliary lens assembly may be attached to the primary lens assembly from the front of the primary lens assembly. In an alternative embodiment of the invention the auxiliary lens assembly may be attached to the back of the primary lens assembly proximal to the face of the wearer.

Micromagnets

The present invention relies on one or more micromagnets to achieve removable coupling of a primary lens assembly to an auxiliary lens assembly within an eyewear system. The following is a discussion of the characteristics of suitable micromagnets for application in accordance with the invention.

Composition

Traditional or more conventional magnet types applied to eyewear systems, such as Ceramic (or Ferrite) or Alnico, have several shortcomings as previously noted. Rare earth magnets, which are the basis of the micromagnets applied in accordance with invention, however, are a class of permanent magnets made out in part of lanthanides or actinides elements of the periodic table. Rare earth magnets are available in sintered and bonded forms, which refers mainly to the production process. Sintered magnets are composed of the compressed powder of the alloy material being used. Sintering involves the compaction of fine alloy powder in a die and then fusing the powder into a solid material. Bonded magnets use a polymer base to hold the alloy powder together. The maximum energy product (BH)ₘₐₓ of bonded magnets can end up being lower than that of sintered magnets.

According to one aspect of the invention, micromagnets suitable for facilitating the coupling of a primary lens assembly with an auxiliary lens assembly include at least one rare earth element chosen from the lanthanides (atomic numbers 57-71) and actinides (atomic numbers 89-103) series of the periodic table of elements.

Micromagnets used according to an embodiment of the invention can be made of an International Electrotechnical Commission (IEC) Code Reference R4-1 material. Various alloy compositions which may qualify as an R4-1 material are well known in the art (see the MMPA Standard for reference to specific alloys).

Micromagnets used according to a further embodiment of the invention can be made of an International Electrotechnical Commission (IEC) Code Reference R5-1 material. Various alloy compositions which may qualify as an R5-1 material are well known in the art (see the MMPA Standard for reference to specific alloys).

Micromagnets used according to another embodiment of the present invention are made of an alloy comprising between 34 and 39 percent by weight Neodymium (Nd).

Micromagnets used according to still another embodiment of the present invention are made of an alloy comprising between 22 and 29 percent by weight Samarium (Sm).

Micromagnets used according to another embodiment of the present invention are made of an alloy comprising between 30 and 35 percent by weight Samarium (Sm).

The micromagnets according to another embodiment of the present invention are made of an alloy comprising between 34 and 39 percent by weight Samarium (Sm).

Processes of Manufacture Grades of Magetic Materials and Maximum Energy Product (BH)ₘₐₓ

Micromagnets as contemplated according to the invention may be produced by any method or process which can take micromagnetic material and give rise to a micromagnet of similar remanent induction B_{d} as a conventional Ceramic or Alnico magnet that may be applied to an eyewear system, but in the form of a magnet with a smaller volume and still capable of facilitating the coupling a primary lens assembly with an auxiliary lens assembly.

In one embodiment of the invention, micromagnets are manufactured using sintering processes well known in the art (see MMPA Standard). The micromagnetic material produced during the sintering process may be magnetized during the sintering process or alternatively the micromagnetic materials may be magnetized (using standard induction methods after being affixed in some manner to a primary or auxiliary lens assembly and still provide for micromagnets of a sufficient remanent induction B_{d} to facilitate the coupling of lens assemblies in the eyewear systems of the invention.

The micromagnets described herein can be calibrated, during production, to a certain grade. Ferromagnetism is a property not only of the individual atoms or ions in a material but also of the interaction of these individual atoms or ions with its neighbours in the crystal lattice of the material. This allows for a certain calibration of ferromagnetic material into magnets having different magnetic properties. In the case of most rare earth magnets, this calibration is directly related to the manufacturing process applied. The grade of a magnet directly refers to the maximum energy product (BH)ₘₐₓ (usually expressed in MGOe, where 1 MGOe=7,957 J/m³) of the material that composes the magnet. For example, a grade 36 magnet will have a maximum energy product (BH)ₘₐₓ of approximately 36 MGOe. The maximum energy product (BH)ₘₐₓ, however, does not refer to the physical and chemical composition of the magnet. The grade is generally only used to describe the potential maximum strength of a magnetic material. A micromagnet of a higher grade magnetic material may be produced, however, to exhibit an actual strength similar to a micromagnet produced of a lower grade magnetic material depending on the timing of the magnetization procedures applied during the micromagnet manufacturing process.

Methods for producing different grades of micromagnetic materials are and have been used in other industries for approximately two decades (for example, micromagnets as described herein are available from AMR Technologies Inc. of Toronto, Canada, Magnequench, Inc., Singapore and Electron Energy Corporation of Landisville, Pa., USA; see also the following patents U.S. Pat. No. 4,802,931, U.S. Pat. No. 4,851,058, U.S. Pat. No. 5,174,362, and U.S. Pat. No. 5,411,608). Methods for measuring maximum energy product (BH)ₘₐₓ or the actual energy product of micromagnets are also well known in the art.

The notion of magnetic moment can be important when considering the behaviour of magnetic materials. Particular materials where the magnetic moment of each atom can be made to favour one direction are said to be magnetizable and the extent of this phenomenon is called the magnetization. A torque or magnetic moment tends to align its axis in the direction of a magnetic field. This torque increases with the strength of the poles and their distance apart. Magnetic moment is a vector quantity which has both a direction and a magnitude. Hence, the value of a magnetic moment provides, in effect, an indication of how powerful a magnet is.

The micromagnets according to an embodiment of the invention is made of a magnetic material of a maximum energy product (BH)ₘₐₓ of at least approximately 180 kJ/m³ (or approximately 22 MGOe).

The micromagnets according to an embodiment of the present invention are made of an RE alloy having a maximum energy product (BH)ₘₐₓ of at least 210 kJ/m³.

In one embodiment of the present invention, the micromagnets are sintered neodymium-iron-boron magnets having the following composition Nd₂Fe₁₄B and a maximum energy product (BH)ₘₐₓ of 190 to 400 kJ/m³.

In an alternative embodiment of the present invention, the micromagnets are made through a sintering process and made from an alloy having a RE₂TM₁₄B composition with a maximum energy product (BH)ₘₐₓ of 190 to 400 kJ/m³. In this embodiment, the RE (rare earth metal) can be Neodymium (Nd), Praseodymium (Pr) or Dysprosium (Dr) and the TM (transition metal) can be Iron (Fe) or Cobalt (Co).

In one embodiment of the present invention, the micromagnets are sintered neodymium-iron-boron magnets having the composition Nd₂Fe₁₄B with a maximum energy product (BH)ₘₐₓ of approximately 380 kJ/m³.

In one embodiment of the present invention, the micromagnets are sintered samarium-cobalt magnets having the following composition Sm₂Co₁₇ with a maximum energy product (BH)ₘₐₓ of 190 to 240 kJ/m³. In an alternative embodiment of the present invention, the micromagnets are made through a sintering process and made from an alloy having the composition Sm₂TM₁₇ with a maximum energy product (BH)ₘₐₓ of 190 to 240 kJ/m³. In this embodiment, TM can be Iron (Fe), Copper (Cu), Cobalt (Co), Zirconium (Zr) or Hafnium (Hf).

Intrinsic Coercive Force (H_{ci})

Another significant advantage of using micromagnets in magnetic eyewear applications is their high intrinsic coercive force H_{ci}. As discussed previously, the intrinsic coercive force H_{ci} of a material indicates its resistance to demagnetization. It is equal to the demagnetizing force which reduces the intrinsic induction in the material to zero after magnetizing to saturation, measured in oersteds. Materials having a higher intrinsic coercive force H_{ci} keep their magnetic properties longer than materials with a lower intrinsic coercive force, under similar conditions.

In an embodiment of the invention the intrinsic coercive force H_{ci} of micromagnets associated with a primary or auxiliary lens assembly is at least approximately 7000 oersteds.

In an embodiment of the present invention, the micromagnets associated with a primary or auxiliary lens assembly have an intrinsic coercive force H_{ci} of approximately 7000 to 41000 oersteds. In another embodiment of the invention, the micromagnets associated with a primary or auxiliary lens assembly have an intrinsic coercive force H_{ci} of at least approximately 11000 oersteds. In a further embodiment of the present invention, the micromagnets associated with a primary or auxiliary lens assembly have an intrinsic coercive force H_{ci} of approximately 11000 to 26000 oersteds.

Micromagnetic Size and Remanent Induction B_{d}

The gauss value of a magnet is another measure of its actual magnetic properties and is related to its composition and size among other things. In order to facilitate the coupling of a primary lens assembly with an auxiliary lens assembly the one or more magnets applied must provide for a total remanent induction B_{d} of at least approximately 1000 gauss.

Typically, micromagnets are not pressed into individual magnets during initial production steps and are instead pressed into block that are larger than the desired final size and then sectioned so that individual micromagnets will have consistent magnetic properties. In general a micromagnet may be as little as one tenth the volume of a conventional Ceramic or Alnico magnet and still have comparable magnetic properties that can be relied upon to facilitate the coupling of a primary lens assembly with an auxiliary lens assembly.

According to an embodiment of the invention, micromagnets incorporated within the eyewear system of the invention provide for a total remanent induction B_{d} of approximately 1000 to approximately 1500 gauss.

According to an embodiment of the present invention, one or more micromagnets within the eyewear system of the invention provide a total remanent induction B_{d} of at least approximately 1500 gauss.

According to another embodiment of the invention, one or more micromagnets within an eyewear system of the invention provide for a total remanent induction B_{d} from approximately 1500 to approximately 2000 gauss.

According to a further embodiment of the present invention, one or more micromagnets within an eyewear system of the invention provide a total remanent induction B_{d} of at least approximately 2000 gauss.

According to another embodiment of the present invention, one or more micromagnets within an eyewear system of the invention provide a total remanent induction B_{d} from approximately 2000 to approximately 4000 gauss.

In one embodiment of the present invention, the micromagnets are less than approximately 0.45 mm in height, less than approximately 0.45 mm in width, and being approximately 1.2 mm in length.

In one embodiment of the present invention, the micromagnets are less than approximately 0.45 mm in height, less than approximately 0.45 mm in width, and being approximately 2 mm in length.

In one embodiment of the present invention, the micromagnets are less than approximately 3 mm wide by 1 mm in length by 0.5 mm in thickness, where the thickness is the axis of the magnetic coupling.

In one embodiment of the present invention, the micromagnets are less than approximately 4 mm by 4 mm, and where the length, being longer than the cross-sectional dimensions, defines the axis of coupling.

In one embodiment of the present invention, the micromagnets are less than approximately 2 mm wide by 1 mm in length by 0.5 mm in thickness, where the thickness is the axis of the magnetic magnetization.

In one embodiment of the present invention, the micromagnets are less than approximately 0.55 mm in height, less than approximately 0.55 mm in width, and being at least 1.2 mm in length.

Maximum Operating Temperature Tₘₐₓ

Micromagnets have a lower maximum operating temperature Tₘₐₓ than most conventional Ceramic or Alnico which can function at temperatures in excess of 450 degrees centigrade. The maximum operating temperature Tₘₐₓ of micromagnets, however, is nonetheless high still enough for use within the magnetic eyewear system of the invention. The micromagnets described herein have a maximum operating temperature Tₘₐₓ of approximately 80 to approximately 350 degrees centigrade.

According to an embodiment of the present invention, the maximum operating temperature Tₘₐₓ is at least 80 degrees centigrade.

According to an embodiment of the present invention, the maximum operating temperature Tₘₐₓ is at least 120 degrees centigrade.

Positioning of Micromagnets

The position of one or more micromagnets in an eyewear system of the invention may vary depending on whether the primary and auxiliary lens assemblies have frame portions, and the positioning of magnetically attractable material in complementary mating areas. The positioning may also facilitate to increase the strength of the magnetic attraction provided by the micromagnents, the stability of the coupling between the primary and auxiliary lens assemblies, including maintenance of a desirable alignment between the two lens assemblies.

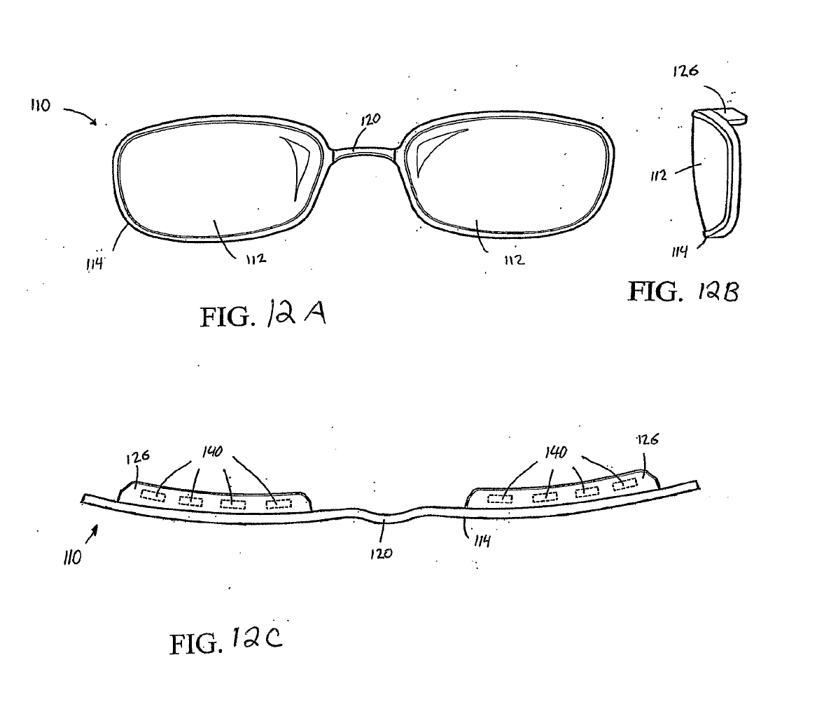

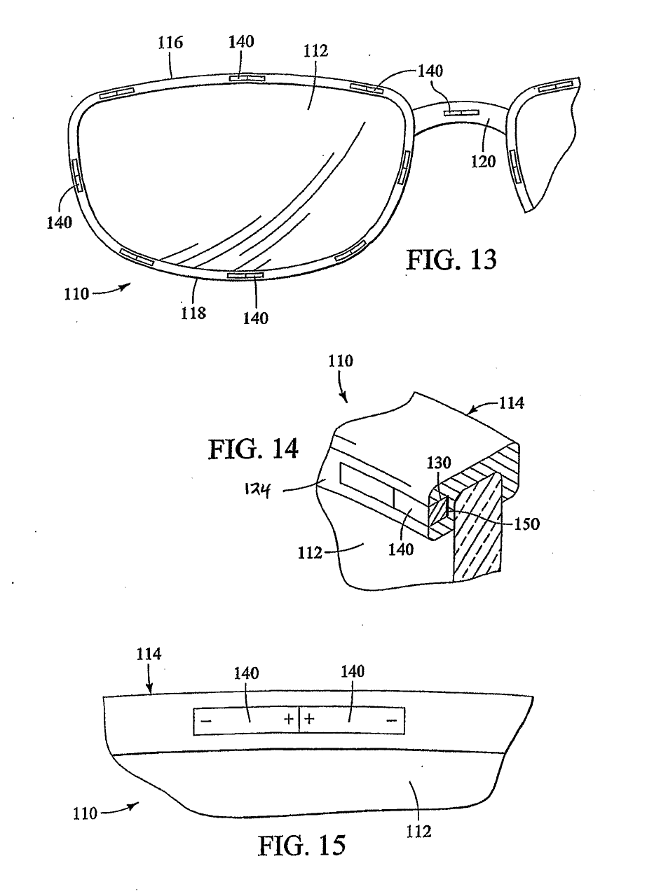

In an embodiment of the invention, multiple micromagnets are located in a single slot, each having one pole facing outwardly from the slot. In a variation of this embodiment, at least two micromagnets are located in close proximity, with common magnetic poles located in end-to-end alignment, as shown below and illustrated in FIGS. 13, 14 and 15:

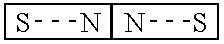

The small size and relatively high maximum energy product and magnetization of micromagnets allow for such a common magnetic poles located in end-to-end configuration in an embodiment of the present invention. In this embodiment, the coupling between a mating area comprising the micromagnets with a common magnetic poles located in end-to-end configuration and a complementary mating area would happen in a plane which is substantially perpendicular to the axis of the North-South poles of the micromagnets. Arranging common magnetic poles in an end-to-end configuration is possible because of the small size and relatively high maximum energy product of the micromagnets and also the fact that the poles are located closer one to another creating shorter but stronger magnetic fields. Specifically, end-to-end alignment of like or “common” poles allows for increased strength over the more conventional end-to-end alignment of opposite or “uncommon” poles.

The micromagnets according to the present invention can be affixed to the mating areas in various ways. They can be surface mounted or embedded within receded slots in the mating areas of the primary or auxiliary lens assemblies. Where the micromagnets are embedded within the said slots, the mating surface of the micromagnets can be slightly receded, protruding or flush in relation to the surface of the area immediately surrounding the slot. The micromagnets are secured to the primary or auxiliary lens assemblies with adhesives or through frictional force between the micromagnets and the corresponding slots. Adhesives are commercially available and well known in the art for attaching magnets into slots in eyewear. The same adhesives are applicable for attaching micromagnets to lens assemblies. The mating surfaces of the micromagnets can also be thinly coated with a material, such as an epoxy layer allowing for a smoother finish of the mating area comprising the micromagnets and also some level of protection for the micromagnets from corrosion. Such coatings may also prevent the micromagnets on one lens assembly from damaging the complementary mating area on another lens assembly.

Moreover, any combination of micromagnets used singularly, or in combination, can be employed in any embodiment described herein.

The various embodiments disclosed herein which include magnetic attraction will be appreciated by one of ordinary skill in the art to involve a combination of micromagnet-to-micromagnet magnetic engagement, or engagement between a micromagnet and a magnetically attractable material which is other than a micromagnet.

Moreover, any combination of micromagnets used singularly, or in combination, can be employed in any embodiment described herein.

The various embodiments disclosed herein which include magnetic attraction will be appreciated by one of ordinary skill in the art to involve a combination of micromagnet-to-micromagnet magnetic engagement, or micromagnet-to-magnetically attractable material engagement.

With relatively high maximum energy product (BH)ₘₐₓ, and higher intrinsic coercive force H_{ci}, the micromagnets as described herein have significant superior characteristic than traditional Alnico and Ceramic (Ferrite) magnets in eyewear applications, making micromagnets appropriate for use within embodiments of the present invention.

In order to further describe the various embodiments of the present invention, a more detailed description of the figures will follow.

General Primary and Auxiliary Lens Assemblies

FIG. 1 is an isometric view of an embodiment of the present invention. In this view, a primary lens assembly 10 is illustrated with an auxiliary lens assembly 110 coupled thereto, by way of some form of magnetic engagement.

FIG. 2 is an isometric breakout view illustrating the auxiliary lens assembly being connected to the primary lens assembly 10. As best seen in FIG. 2, primary lens assembly 10 has a pair of primary lenses 12 secured in a primary frame 14. Primary frame 14 has an upper portion 16 and a lower portion 18. Primary frame 14 has a primary bridge 20 that secures primary lenses 12 of primary lens assembly 10 in fixed relation to each other. Primary frame 14 is made, completely or partially, of magnetically attractable material.

A side extension 30 extends generally rearward from primary frame 14, between upper portion 16 and lower portion 18. An arm 40 is pivotally connected to each extension 30 for supporting and engaging primary lens assembly 10 on the head of the wearer.

Still referring to FIG. 2, auxiliary lens assembly 110 is also partially illustrated. Auxiliary lens assembly 110 has a pair of auxiliary lenses 112 secured in an auxiliary frame 114. Auxiliary frame 114 has an upper portion 116 and a lower portion 118. Auxiliary frame 114 has an auxiliary bridge 120 that secures auxiliary lenses 112 of auxiliary lens assembly 110 in fixed relation to each other. Auxiliary frame 114 can be comprised, completely or partially, of magnetically attractable material.

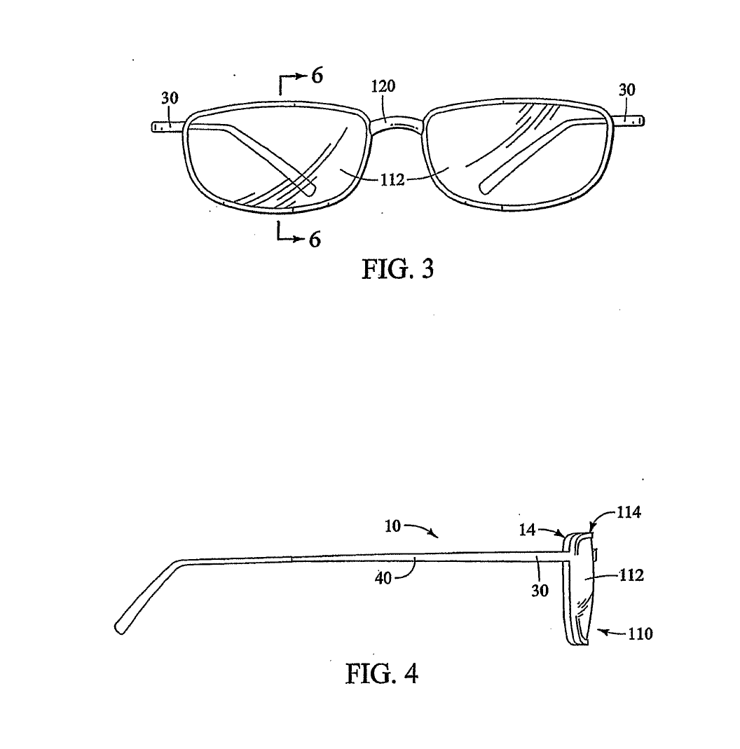

FIG. 3 is a front view of auxiliary lens assembly 110 coupled to primary lens assembly 10 in accordance with an embodiment of the present invention. FIG. 4 is a side view of the same embodiment where auxiliary lens assembly 110 is coupled to primary lens assembly 10 as illustrated in FIG. 3. As seen in FIG. 3, when primary lens assembly 10 and auxiliary lens assembly 110 are coupled, auxiliary lenses 112 and primary lenses 12 are in substantial alignment.

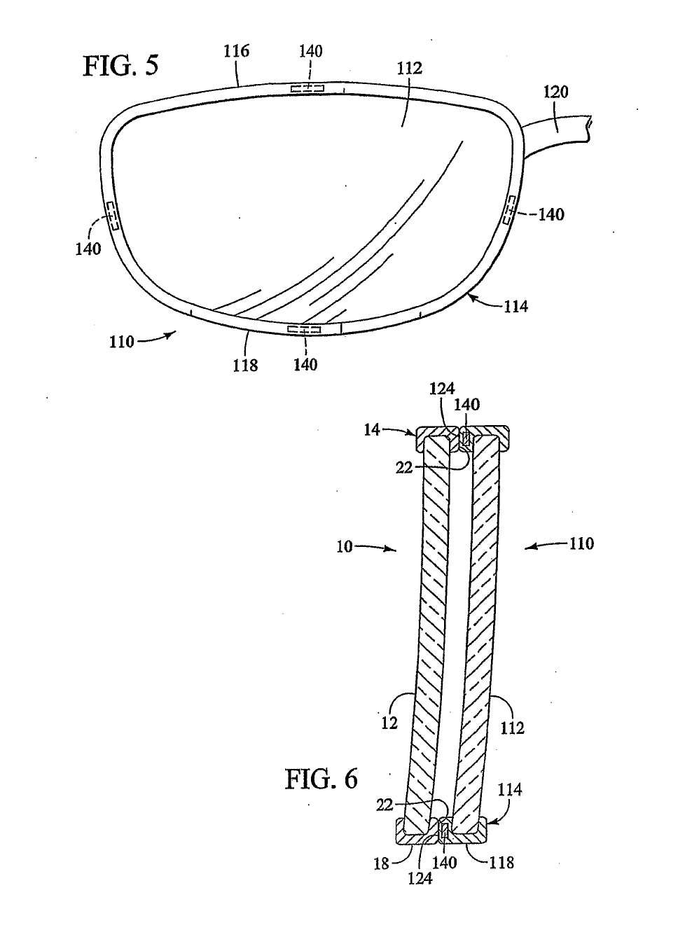

FIG. 5 is a rear break-out view of auxiliary lens assembly 110 of the present invention. In this view, it is seen that auxiliary lens assembly 110 has micromagnets 140 located in slots, said slots located in the back 124 of auxiliary frame 114.

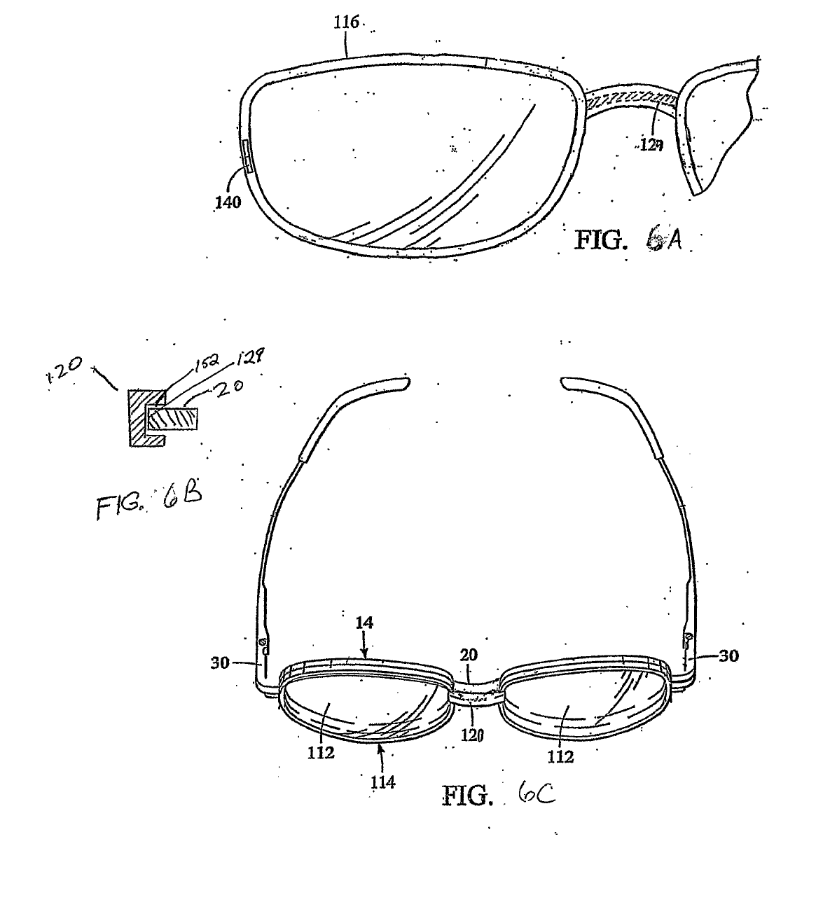

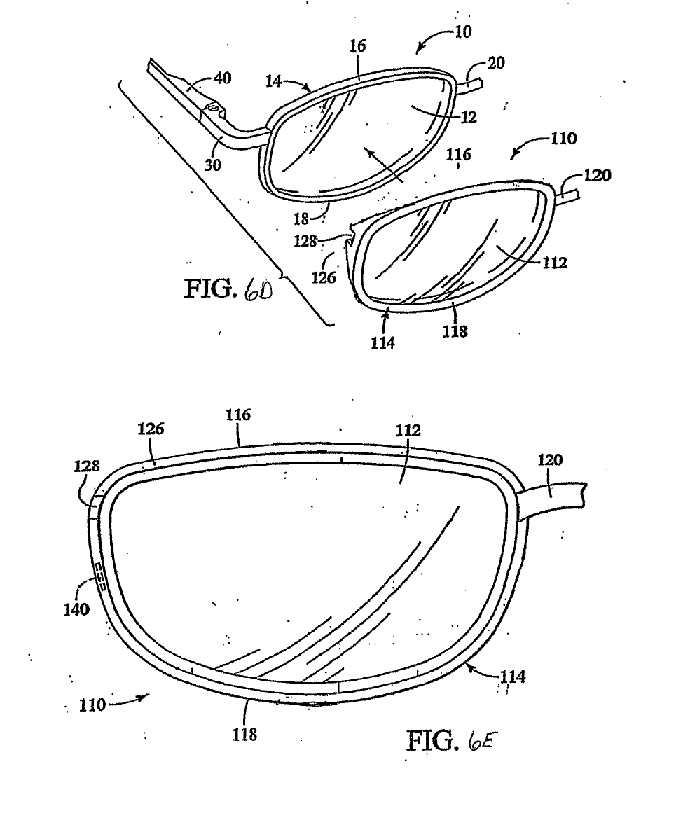

FIG. 6 illustrates that primary frame 14 has a front 22 and a back 24. Back 24 of primary frame 14 is proximate to the face of the person wearing primary lens assembly 10. Front 22 of primary frame 14 faces away from the wearer. It further illustrates that auxiliary frame 114 has a front 122 and a back 124. Back 124 of auxiliary frame 114 is proximate to the face of the person wearing auxiliary lens assembly 110. Front 122 of auxiliary frame 114 faces away from the wearer.

FIG. 6 is a side-sectional view as indicated in FIG. 3, and illustrates the relationship between primary frame 14 and auxiliary frame 114 when primary lens assembly 10 and auxiliary lens assembly 110 are coupled. As seen in this view, front 22 of primary frame 14 is in contact and substantial alignment with back 124 of auxiliary frame 114, allowing and resulting from magnetic engagement between micromagnets 140 and primary frame 14.

Primary and Auxiliary Assemblies with Alignment Structures

In an embodiment of the present invention depicted in FIGS. 6A to 6C, the auxiliary lens assembly 114 possesses an alignment groove 152 in the auxiliary bridge 120 designed to be complementary the primary bridge 20 of the primary frame 116 to assist in the alignment between the respective mating areas 160 of the primary lens assembly 14 and the auxiliary lens assembly 114. The primary bridge 20 may have a protrusion 129 to facilitate in the alignment between the respective mating areas 160 of the primary lens assembly 14 and the auxiliary lens assembly 114.

FIG. 6A is a rear break-out view of an alternative embodiment of the auxiliary lens assembly of the present invention, illustrating slots and micromagnets 140 located in on the rear of the auxiliary frame 116 as well as the groove in the auxiliary bridge 129. This groove is designed to accommodate the bridge of the primary frame so as to assist in the alignment of the micromagnets 140 with the primary frame.

FIG. 6C is an isometric view of an auxiliary lens assembly 114 coupled to a primary lens assembly 14 in accordance with an embodiment of the present invention, which illustrates the bridge of the primary frame 20 interacting with the complementary groove in the auxiliary frame 120.

The embodiments of primary frame 14 and auxiliary frame 114 illustrated surround the entire perimeter of primary lenses 12 and auxiliary lenses 112 respectively. Alternatively, primary frame 14 may only partially surround the perimeter of primary lenses 12. Likewise, auxiliary frame 114 may only partially surround the entire perimeter of auxiliary lenses 112. Such configurations are known in the industry as “open edge.”

In another embodiment, primary lenses 12 are attached directly to primary bridge 20. In this embodiment, extensions 30 are attached directly to primary lenses 12. In another embodiment, auxiliary lenses 112 are attached directly to auxiliary bridge 120. Such configurations are known in the industry as “frameless.”

In an alternative embodiment of the present invention, an alignment groove is located in the primary bridge 20 designed to be complementary the auxiliary bridge 120 of the primary frame 116 to assist in the alignment between the respective mating areas 160 of the primary lens assembly 14 and the auxiliary lens assembly 114. The auxiliary bridge 120 may have a protrusion to facilitate in the alignment between the respective mating areas 160 of the primary lens assembly 14 and the auxiliary lens assembly 114.

In another embodiment of the present invention, depicted in FIG. 6D and FIG. 6E, the auxiliary lens assembly 114 possesses a pair of side alignment groove 128 in the auxiliary bridge 120 designed to be complementary the primary side extensions 30 of the primary frame 16 to assist in the alignment between the respective mating areas 160 of the primary lens assembly 10 and the auxiliary lens assembly 110.

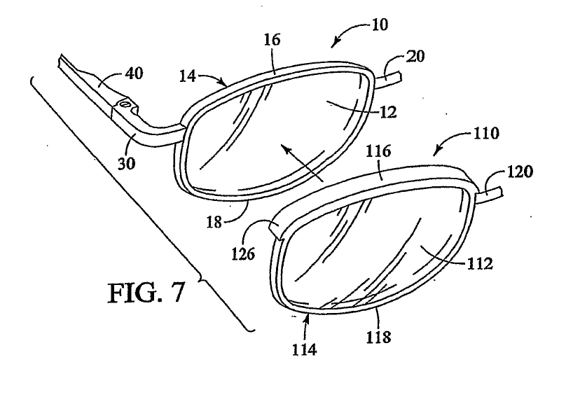

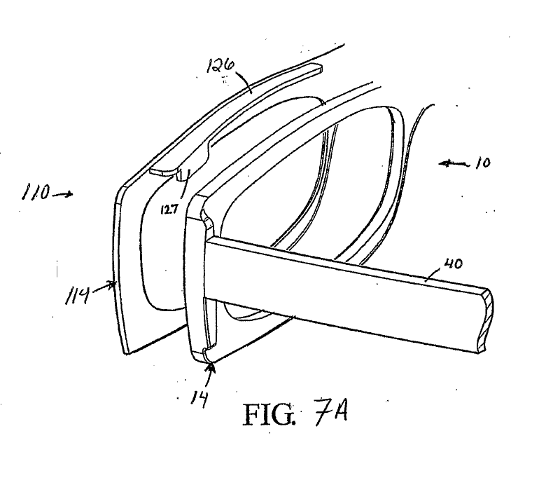

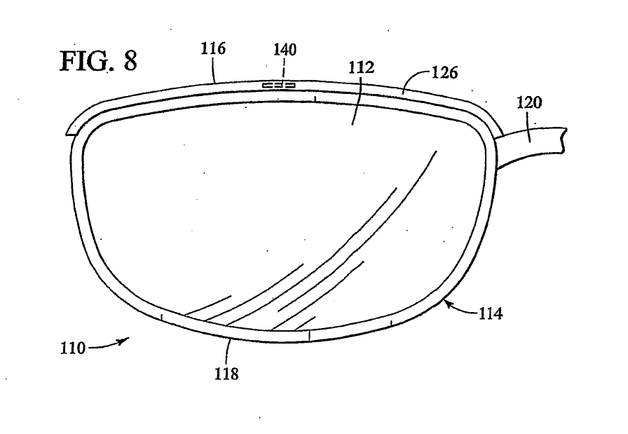

FIG. 7 is an isometric breakout view of an alternative embodiment of the present invention, illustrating auxiliary lens assembly 110 having a shelf 126 extending from back 124 of upper portion 116 of auxiliary frame 114. FIG. 8 is a rear breakout view of auxiliary lens assembly 110 illustrated in FIG. 7. In this view micromagnets 140 are located in the slots contained in shelf 126 of auxiliary frame 114.

FIG. 7A illustrates a further embodiment of the present invention where a hooking means is located on the back of the shelf, said means is designed to be a length no greater than the thickness of the eyewear on the primary frame. In one embodiment, the hooking means, is retaining tab 127, where tab 127 engages surface 24 of the primary frame assembly 10.

The one or more shelves may be located along the entire length or at one or more position along the top portion, bottom portion and/or outer portions of the auxiliary frame. In one embodiment the shelves are located along the top portion of the auxiliary frame over each of the auxiliary rims, but not over the auxiliary bridge.

In another embodiment the shelf is located over the auxiliary bridge only.

In another embodiment of the present invention the one or more shelves further comprise a one or more retaining tabs 127 extending down from the back of the bottom portion of the one or more shelves. The retaining tabs 127 prevent the auxiliary frame from being dislodged by a momentary shock, for example, a sudden horizontal displacement.

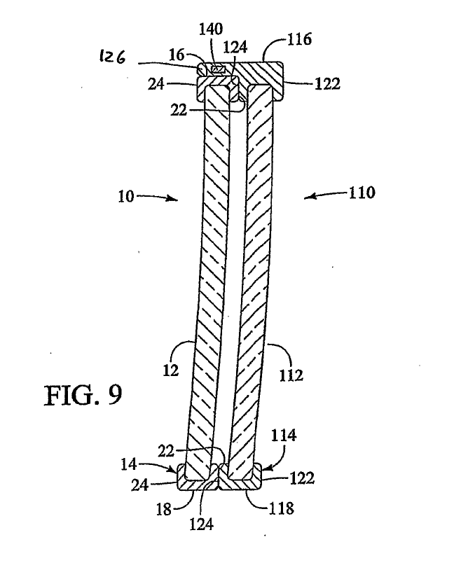

FIG. 9 is a side-sectional view of the embodiment illustrated in FIGS. 7 and 8 as described above. In this view, auxiliary lens assembly 110 is shown coupled to primary lens assembly 10. Also in this view, it can be seen that shelf 126 mechanically engages with the upper portion 16 of primary frame 14 to provide additional resistance to undesired disengagement when vertical separating forces are encountered. It is also seen in this view that micromagnets 140 can be located and either shelf 126, or back 124 of upper portion 116 of auxiliary frame 114. Alternatively, micromagnets 140 can be located in both places.

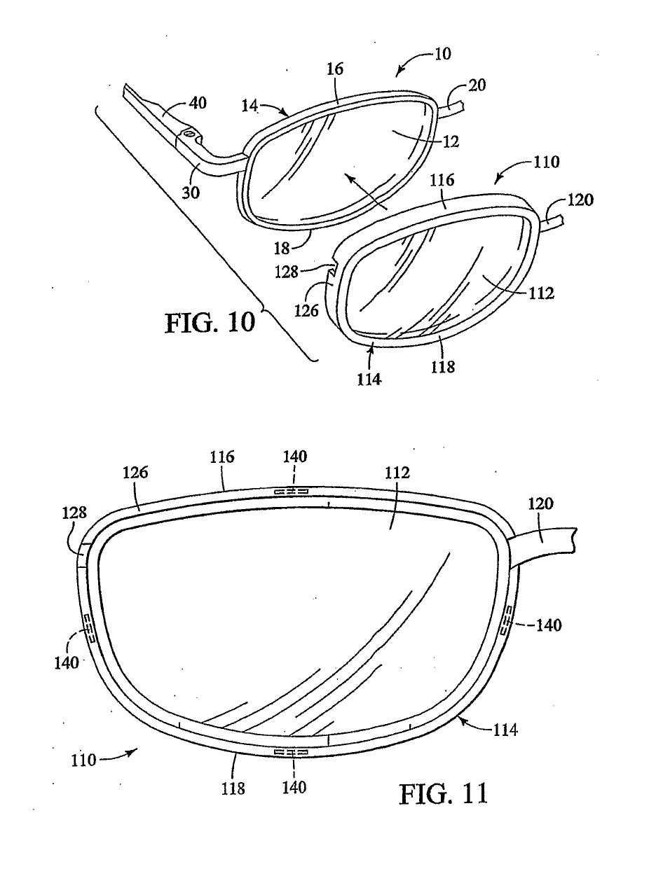

FIG. 10 is an isometric breakout view of another embodiment of the present invention, illustrating auxiliary lens assembly 110 having shelf 126 extending from a majority of the perimeter of back 124 of auxiliary frame 114. An additional embodiment includes a relief 128, which accommodates extension 30 of primary frame 14 of primary lens assembly 10.

FIG. 11 is a rear break-out view of auxiliary lens assembly 110 of the present invention, illustrating micromagnets 140 located in slots which are located in back 124 of auxiliary frame 114.

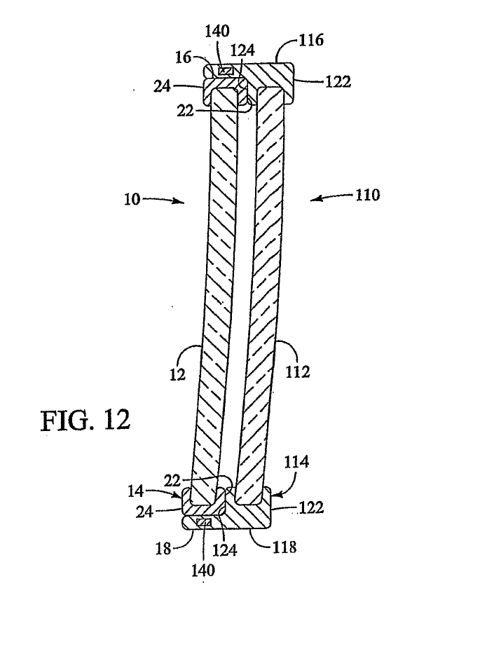

FIG. 12 is a side-sectional view, illustrating the relationship between primary frame 14, auxiliary frame 114, and perimeter surrounding shelf 126, when primary and auxiliary lens assemblies 10 and 110 are coupled.

In another embodiment of the invention, illustrated in FIG. 12a to 12C, auxiliary lens assembly 10 has a shelf 126 extending from back 124 of upper portion 116 of auxiliary frame 114, the shelf 126 having a plurality of micromagnets 140 comprised within one or more mating areas 160.

In an alternative embodiment of the invention, auxiliary lens assembly 10 has two or more shelves 126 extending from back 124 of upper portion 116 of auxiliary frame 114, the shelves 126 having a plurality of micromagnets 140 within one or more mating areas 160.

FIG. 13 is a rear break-out view of an alternative embodiment of auxiliary lens assembly 110 of the present invention, illustrating micromagnets 140 located slot 130 located in back 124 of auxiliary frame 114. As seen in this view, micromagnets 140 are paired together and can be orientated such that common poles are located in matched proximity. FIG. 14 is a sectional break-out cross section of the embodiment disclosed in FIG. 13.

FIG. 15 is a rear close-up view of the embodiment disclosed in FIG. 13, illustrating micromagnets 140 located in the back of the auxiliary frame 114, in which micromagnets are paired together with common poles located matched in close proximity.

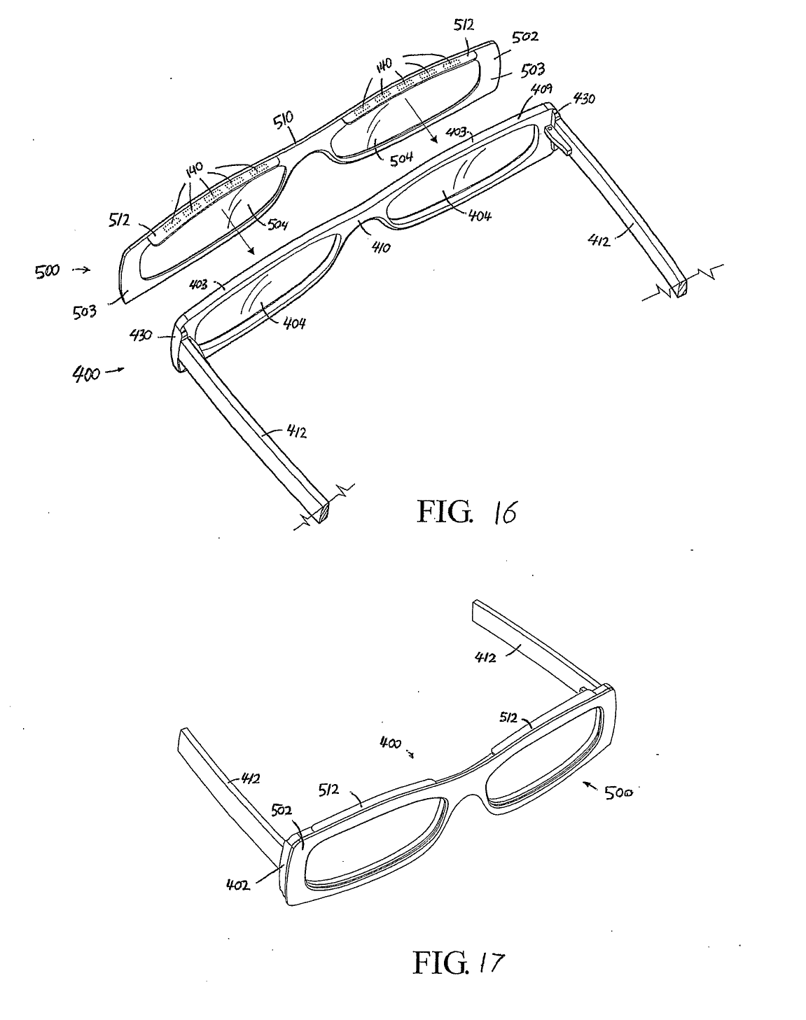

A further embodiment of the present invention provides an eyewear system for magnetically coupling an auxiliary lens assembly to a primary lens assembly made of non-magnetically attractable material. With reference to FIGS. 16 and 17, there is depicted a primary lens assembly 400 comprising a primary frame 402; having a pair of primary lenses 404 affixed within the primary frame 402; a primary bridge 410 securing the primary lenses 404 in fixed relationship to each other; a pair of side extensions 430 located on the outer edges of the primary frame 402; and a pair of arms 412 pivotally connected to the side extensions 430, and extending substantially backwards from the side extensions 430, towards the wearer of the primary lens assembly 400. In another embodiment, each of the rims 403 of the primary frame 402 may be a partial rim wherein only a portion of the primary lens 404 is secured to the rim.

As depicted in FIG. 17, when mounted to the primary frame 402, the auxiliary frame 502 is removably secured to the primary frame 402 via magnetic engagement between the one or more auxiliary shelves 514 of the auxiliary frame with the one or more magnetically attractable elements of the primary frame. To enable the magnetic engagement, the auxiliary frame 502 and primary frame 402 are designed such that the one or more micromagnets 140, mounted on the auxiliary frame 502, are located in positions corresponding with the relative positions of the mating areas 409 on the primary frame 402. The auxiliary lenses 504, when the auxiliary frame 402 is mounted to the primary frame 502, are in substantial alignment with the primary lenses 404 of the primary frame 402.

The primary frame 402 can be formed from one or more plastics, composites, and/or non-magnetically attractable metals and/or alloys, including but not limited to plastic, carbon fiber, graphite and non-magnetic stainless steel or any combination thereof. In one embodiment the primary frame is formed from injection molded plastic. In another embodiment of the present invention, the primary frame is formed of non-magnetic memory metal alloy. Other methods of manufacturing said frames to achieve the end product are well known to those skilled in the art.

The primary frame 402 has a top portion, bottom portion, outer portions, front and back (not shown). The top portion comprises the top of the bridge 410 and the top each of the lens rims 403 of the primary frame 402. The front of the primary frame 402 faces away from the person wearing the primary lens assembly 400. The back of the primary frame 402 is proximate to the face of the person wearing the primary lens assembly 400. Associated with the primary frame are one or more mating areas 409, comprising magnetically attractable material. The magnetically attractable material includes any material having ferromagnetic properties. Said mating areas 409 are associated with the top portion, bottom portion, outer portions and/or the front of the primary frame 402.

In one embodiment of the present invention, the primary lenses are prescription lenses to correct the vision of the wearer. As would be known to a worker skilled in the art, the prescription lenses may be single vision, bifocal, trifocal, progressive or other types of lenses. In another embodiment, the primary lens is impact resistant safety lens.

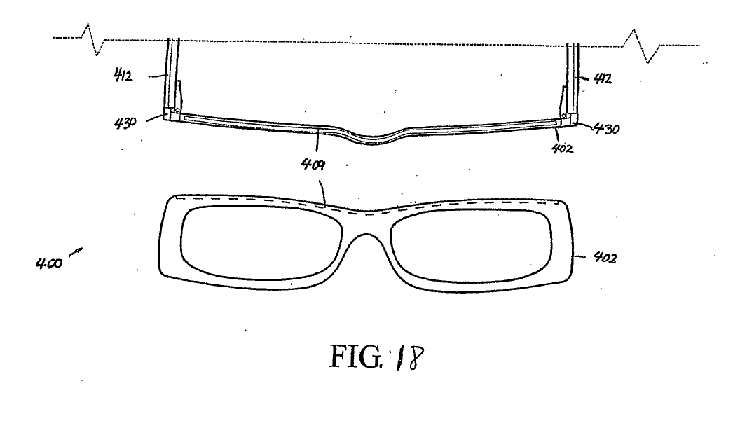

With reference to FIGS. 18 and 19 the mating area 409 is in the form of a single magnetically attractable strip secured along substantially the entire outer periphery of the top portion of the primary frame 402, as illustrated in FIG. 24. The strip can be secured to the primary frame by means commonly known in the art, including but not limited to adhesive, solder, studs, screws, rivets, friction or embedded into top portion of the primary frame.

In another embodiment (not shown in the figures), a plurality of magnetically attractable strips are secured along mating areas of the outer periphery of the top portion of the primary frame. For example, a magnetically attractable metal strip comprising a top and bottom can be secured to the primary frame using two or more threaded studs located along the bottom of the metal strip. The magnetically attractable metal strip is secured to the primary frame by way of two or more bores located along the top portion of the primary frame. The location of each of the bores corresponds to the location of each of the threaded studs such that when the metal strip is mounted onto the primary frame the threaded studs and bores are engagingly connected. The diameter of the bores can be slightly smaller than the diameter of the threaded studs such that when the threaded studs are inserted into the bores, the pressure from the smaller diameter bore will secure the metal strip and prevent it from dislodgment from the primary frame. Adhesive may be added to a bore where the diameter of the bore is slightly larger than the threaded stud.

In another embodiment of the present invention, depicted in FIGS. 18 and 19, the mating area 409 is a magnetically attractable metal located within the top portion of the primary frame 402. In the embodiment depicted, the magnetically attractable strip is molded into the top portion of the primary frame. In another embodiment, the magnetically attractable strip is sandwiched between the top portion of the primary frame and a cover. The cover (not shown) can be formed of the same material as the primary frame or any other material, for example, plastics, composites, and/or non-magnetically attractable metals and/or alloys. In yet another embodiment of the present invention the magnetically attractable element is a magnetically attractable metal strip 409 located within one or more grooves (not shown) molded into the top portion of the primary frame.

In yet another embodiment of the present invention, depicted in FIG. 19A, the mating area 409 is a magnetically attractable strip located along the inner periphery of each of the lens rims 403 of the primary frame 402. The mating area 409 can surround the entire inner periphery of each of the rims 403 of the primary frame 402. Alternatively, the mating area 409 can partially surround the inner periphery of the rims 403, for example, those portions of the inner periphery relative to the top portion and/or outer portions of the primary frame 402.

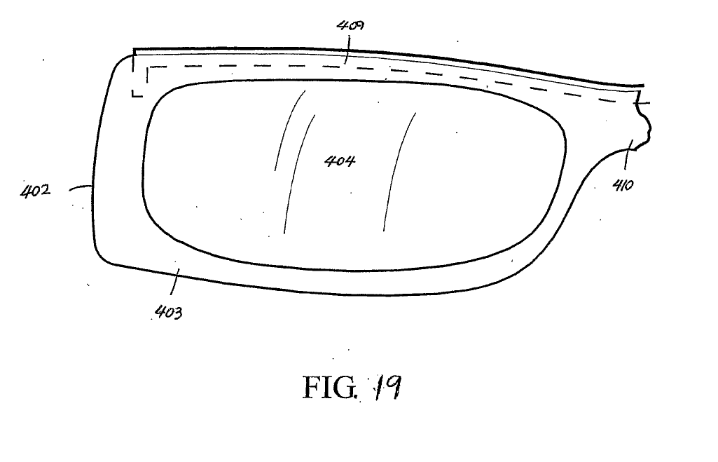

In FIGS. 20 to 22 there is depicted an auxiliary lens assembly 500, having an auxiliary frame 502 comprising a pair of auxiliary lenses 504 secured within auxiliary rims 503. An auxiliary bridge 510 secures the auxiliary rims 503 in fixed relation to each other. The auxiliary frame 502 has a top portion, bottom portion, outer portions, front and back (not shown). The top portion comprises the top of the auxiliary bridge 510 and the top of each of the auxiliary rims 503 of the auxiliary frame 502. The front of the auxiliary frame 502 faces away from the primary frame (not shown), when mounted on the primary frame. The back of the auxiliary frame is proximate to the front of the primary frame, when mounted on the primary frame.

The auxiliary frame can be formed from one or more plastics, composites, and/or non-magnetically attractive metals and alloys, including but not limited to carbon fiber, graphite and non-magnetic stainless steel or any combination thereof. In another embodiment of the present invention, the auxiliary frame is formed of non-magnetic memory metal alloy.

The external shape of the auxiliary frame may be substantially the same as the external shape of the primary frame. In one embodiment of the present invention, the external size of the auxiliary lenses and auxiliary rims are slightly larger than the primary lenses and primary rims. It can be appreciated that the size and shape of the auxiliary frame will vary depending upon the application of the eyewear system, for example, an auxiliary frame for a child may be over-sized and in the shape of a star.

In one embodiment of the present invention, the auxiliary lens is a prescription lens to correct the vision of the wearer. As would be known to a worker skilled in the art, the prescription lens may be single vision, bifocal, trifocal, progressive or other types of lens. In another embodiment, the auxiliary lens is impact resistant safety lens. In yet another embodiment, the auxiliary lens is a light transmission reducing lens, for example, polarizing, absorbing, refracting, photochromatic, reflecting, or any combination thereof.

In another embodiment, the auxiliary rims of the auxiliary frame do not include an auxiliary bridge connecting the auxiliary rims to each other in fixed relation. In yet another embodiment, the auxiliary rims of the auxiliary frame do not include an auxiliary bridge and auxiliary rims containing different auxiliary lenses can be combined interchangeably with a primary lens assembly to satisfy optical, technical or aesthetic requirements.

In another embodiment of the present invention, each of the rims of the auxiliary frame may be a partial rim wherein only a portion of the auxiliary lens is secured to the auxiliary rim.

As illustrated in FIGS. 20-22, one or more shelves 512 are associated with auxiliary frame 502. One or more micromagnets 140 are integrally associated with the one or more shelves 512. The auxiliary lens assembly 500 is removably coupled onto the primary frame 402 by magnetic engagement between the magnetically attractable material associated with the one or more mating areas 409 of the primary frame 402 and the micromagnets 140 associated with the one or more shelves 512 of the auxiliary lens assembly 500.

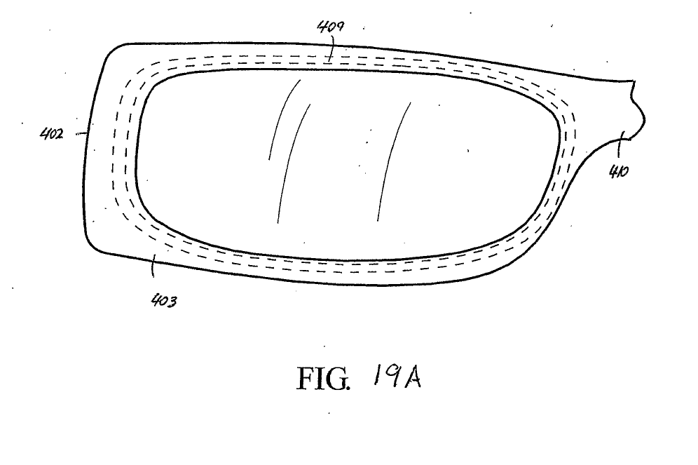

In another embodiment, as illustrated in FIG. 22, one or more slots 511, having a micromagnet 140 secured therein, are located along the interior surface of each of the auxiliary shelves 512. The micromagnets 140 can be embedded in the slots 511 to be flush with the interior surface of the auxiliary shelf 512. Alternatively, the micromagnets 140 can be above or below the interior surface of the shelf 512. The micromagnets 140 are secured to the auxiliary shelves 512 and/or in each of the slots 511 using adhesives that are well known in the art for attaching magnets into slots in eyewear. In another embodiment, the micromagnets 140 are molded into the one or more shelves.

In one embodiment, as depicted in FIGS. 21 and 22, the auxiliary shelves 512 are located along the top portion of the auxiliary frame 502 over each of the auxiliary rims 503, but not over the auxiliary bridge 510. In another embodiment, the one or more auxiliary shelves 512 may be located along the entire length or at one or more position along the top portion, bottom portion and/or outer portions of the auxiliary frame 502. In yet another embodiment the auxiliary shelf is located over the auxiliary bridge only.

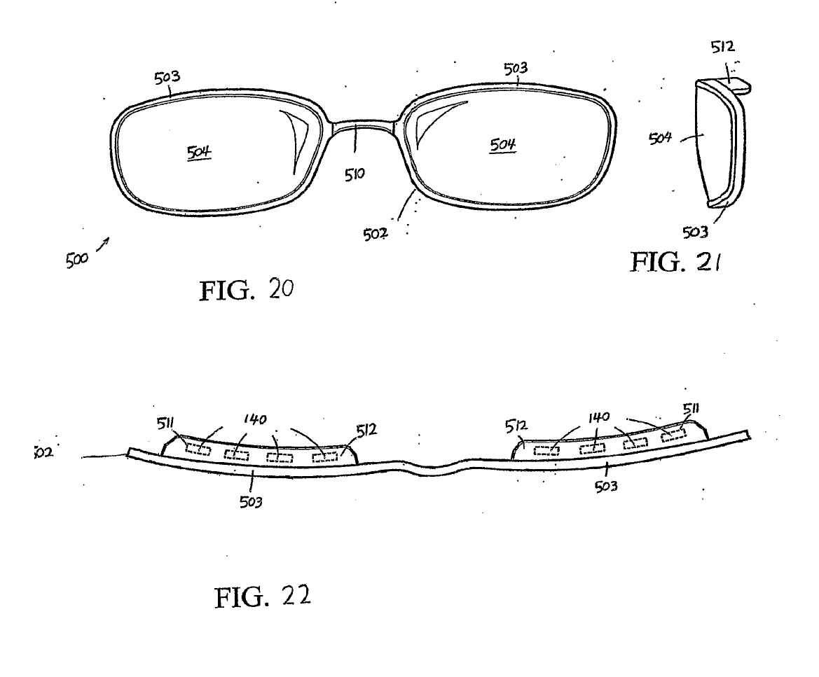

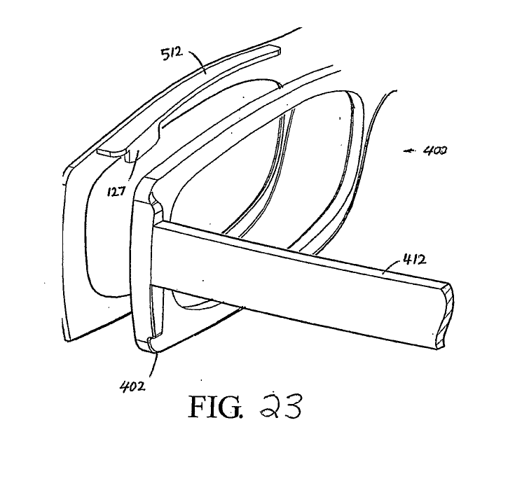

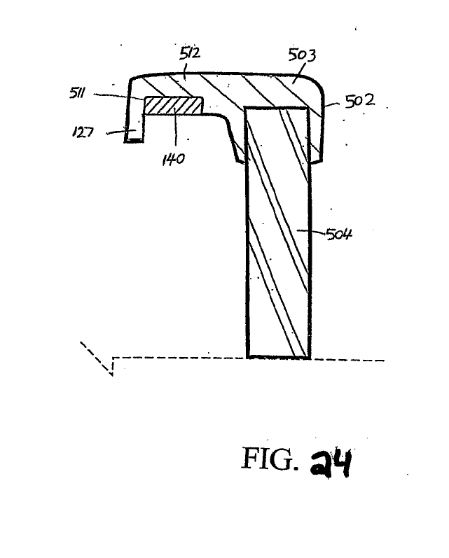

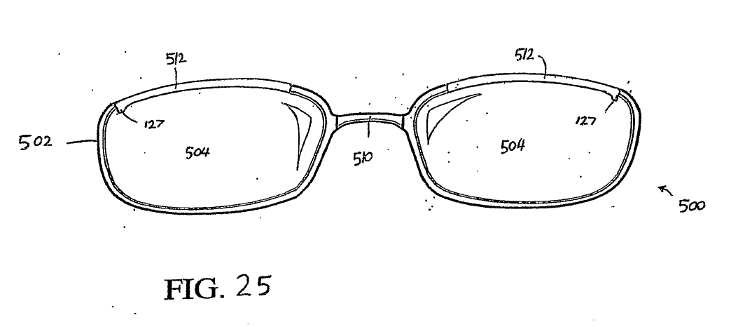

With reference to FIGS. 22, 23, and 24, in another embodiment of the present invention the one or more auxiliary shelves 512 further comprise an engaging means, said means comprising, among others, one or more retaining tabs 127 extending down from the back of the bottom portion of the one or more auxiliary shelves 512. The retaining tabs 127 prevent the auxiliary frame 502 from being dislodged from the primary frame by a momentary shock, for example, a sudden horizontal displacement.

In yet another embodiment of the present invention the one or more shelves further comprise a ridge along the bottom portion of the one or more shelves. For example, the ridge matingly connects with a groove along the top portion of the primary frame. Micromagnets are secured along the ridge. The ridge, when matingly connected to the groove of the primary frame, prevents the auxiliary frame from being dislodged by a momentary shock, for example, a sudden horizontal displacement.

In one embodiment of the present invention, the micromagnets and the magnetically attractable material are in contact when the auxiliary frame is mounted on the primary frame. In another embodiment of the present invention, the magnetic elements and the magnetically attractable elements are in close proximity, but are not touching, when the auxiliary frame is mounted on the primary frame. The distance between the magnetic element and the magnetically attractable element is determined by the force of magnetic attraction between a particular micromagnet and the magnetically attractable element, for example, a micromagnet with a high energy product.

It can be appreciated that the combination of placement of the micromagnets and magnetically attractable materials on the auxiliary frame and primary frame can be varied. For example, the location of the magnetic elements and magnetically attractable elements can be switched on the auxiliary frame and primary frame such that the magnetic elements are placed on the primary frame and magnetically attractable elements are placed on the auxiliary frame. In another example, magnetic elements can be placed on the auxiliary frame that are polarly aligned with mating areas on the primary frame such that magnetic engagement can be achieved to a primary lens assembly.

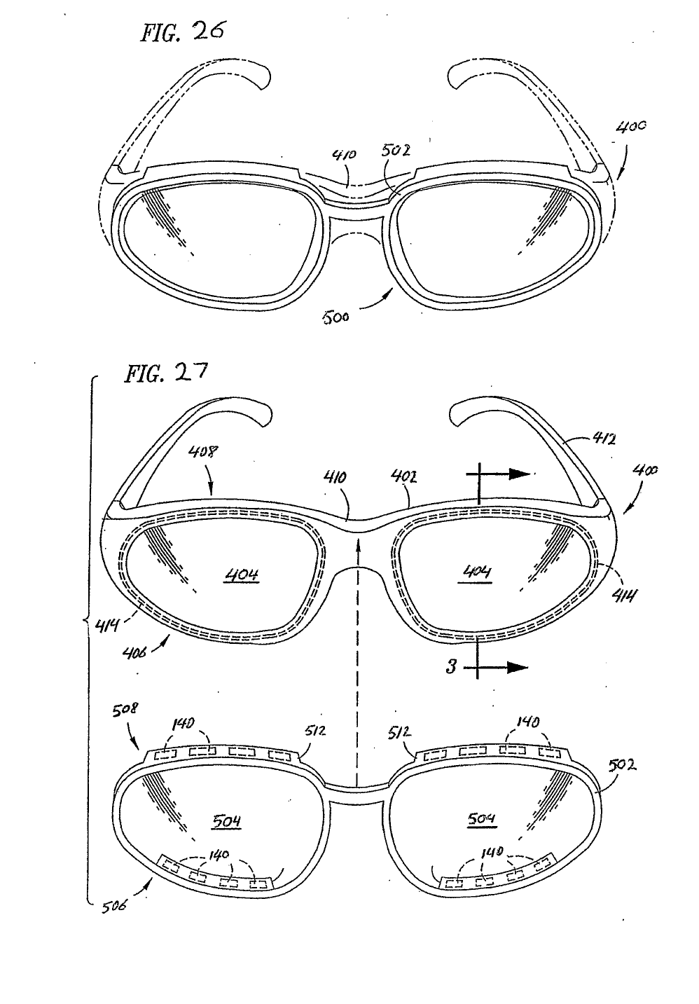

FIGS. 26 and 27 are isometric views of a primary lens assembly 400 coupled to an auxiliary lens assembly 500. Primary lens assembly 400 comprises a primary frame 402 and a pair of primary lenses 404. Primary frame 400 also possesses a front 406 and a back 408. Auxiliary lens assembly 500 couples to primary lens assembly 400 on front 406. Back 408 is positioned in a direction towards the face of the wearer.

As can also be seen in FIGS. 26 and 27, primary frame 402 includes a primary bridge 410 and a pair of arms 412. Primary bridge 410 is located between primary lenses 404 so that primary lenses 404 maintain a fixed position relative to one another. Each of arms 412 extends from an end of primary frame 402 to rest over the ears of the wearer when in use.

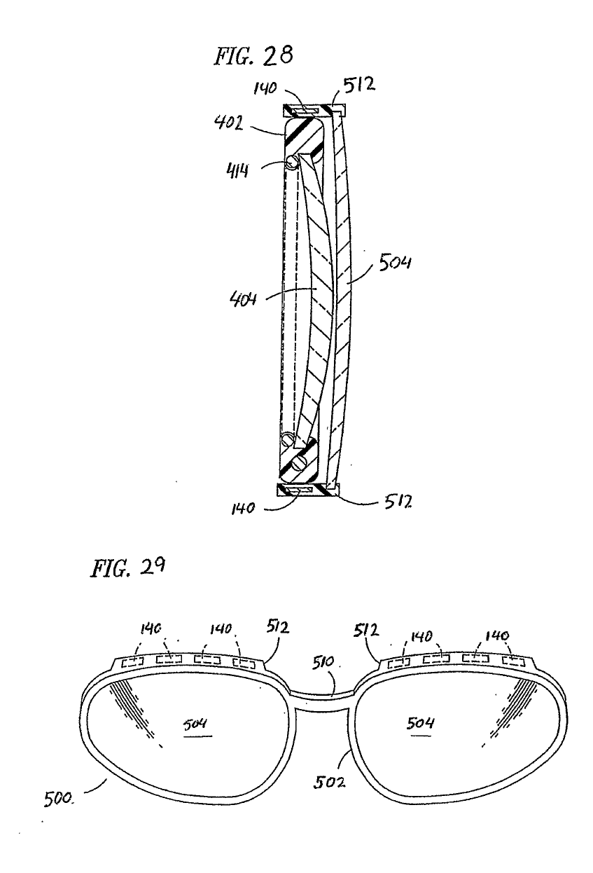

In FIGS. 27 and 28, primary frame 402 includes inserts 414 around each of primary lenses 404. Typically, primary frames 402 are comprised of a non-magnetically attractable substance, such as zylonite or “zyl”. Inserts 414, however, are comprised of a magnetically attractable substance, such as stainless steel or a nickeless stainless steel.

As can also be seen in FIGS. 26 and 27, auxiliary lens assembly 500 comprises an auxiliary frame 502 and a pair of auxiliary lenses 504. Auxiliary lens frame 500 also includes a front 506 and a back 508, where back 508 faces the front of the primary frame 406 when in use.

As also disclosed in FIGS. 26 and 27, auxiliary frame 502 includes an auxiliary bridge 510 and shelves 512. Auxiliary bridge 510 is located between auxiliary lenses 504 so that auxiliary lenses 504 maintain a fixed position relative to one another. Additionally, when in use, auxiliary lenses 504 are in substantial alignment with primary lenses 404. Shelves 512 extend from the periphery of auxiliary frame 502 to position around the periphery of primary frame 402 when in use.

In FIGS. 27 and 29, shelves 512 include micromagnets 140 embedded therein.

Referring to FIGS. 26 through 29 of the drawings, the reference numeral 400 generally designates a primary lens assembly and the reference numeral 500 generally designates an auxiliary lens assembly.

Primary lens assembly 400 is commonly known and referred to as a pair of eyeglasses. Primary lens assembly 400 includes a pair of arms 412 that extend from the periphery in direction toward the face of the wearer and rest over the ears of the wearer.

In addition to having arms 412 support primary lens assembly 400, a primary bridge 410 is included that rests over the nose of the wearer. Primary bridge 410 not only provides support for primary frame 402 over the face of the wearer but also secures primary lenses 404 in fixed position relative to one another, generally over the eyes of the wearer while in use.

When desired, auxiliary lens assembly 500 can be coupled to primary lens assembly 400. When coupled, auxiliary lenses 504 are in substantial alignment with primary lenses 404. Alignment of auxiliary lenses 504 is as a result of auxiliary frame 502 that employs an auxiliary bridge 510 to secure auxiliary lenses in fixed positions relative to one another.

The coupling between auxiliary lens assembly 500 and primary lens assembly 400 is achieved by a magnetic coupling force. Along the periphery of primary frame 402 surrounding each of primary lenses 404 are inserts 414. Inserts 414 on primary frame 402 are generally comprised of stainless steel or nickeless stainless steel. However, one of ordinary skill in the art would well appreciate that another magnetically attractable material could replace either of the stainless steels. To magnetically couple to inserts 414, shelves 512 can be employed having micromagnets 140 embedded therein. As it can be seen in FIG. 27, shelves 512 are located above and below auxiliary lenses 504; however, as shown in FIG. 29, shelves 512 are located in positions above auxiliary lenses 504. Additionally, one of ordinary skill in the art would appreciate that shelves 512 could surround a substantial portion of periphery of primary lenses 504.

Therefore, it can be seen that the present invention provides an umber of benefits over more conventional designs. Specifically, because of the use of inserts 414, additional material can be used to comprise the primary frames 402 such as zylonite, polycarbonate, cellulose propionate, rubber carbon fibre, polyamide, and optyl. It can also be appreciated that a variety of non-magnetic materials, which include dielectric, diamagnetic, and paramagnetic materials, can be used to form primary lens assembly 400. Thus, the primary lens assembly 400 can be used with magnetic auxiliary lens assemblies, such as auxiliary lens assembly 500, while maintaining a higher degree of flexibility with respect to design material than was previously attainable. Additionally, the ability to use plastics or other composites instead of metals, not only increases the design flexibility, but also decreases the costs because of the low production costs often associated with these materials.

FIG. 30 is an isometric view of an embodiment of the present invention, In this view, a primary lens assembly 610 is illustrated with an auxiliary lens assembly 660 detached from primary lens assembly 610.

As can be seen in FIG. 30, primary lens assembly 610 comprises a pair of primary lenses 612. Primary lenses 612 have a front 622 and a back 624. Primary lenses 612 also have holes (not shown) extending there through from front 622 to back 624.

Primary lens assembly 610 further comprises a primary bridge 614 to hold primary lenses 612 in a fixed position relative to one another. In this particular configuration, primary bridge 614 is secured directly to primary lenses 612 without the use of a frame or rims wholly or partially encircling primary lenses 612.

Additionally, primary lens assembly 610 includes a pair of arms 616. Arms 16 are attached, one each, to the outer periphery of primary lenses 612. Arms 616 are secured through holes (not shown) in front 622 of primary lenses 612. When in use, arms 616 can rest in a position over the ears of the wearer. Additionally, when worn, back 624 of primary lens assembly 610 is proximate to the face of the wearer.

Still referring to FIG. 30, auxiliary lens assembly 660 is also illustrated. Auxiliary lens assembly 110 has a pair of auxiliary lenses 662. Auxiliary lenses 662 each have a front 672 and a back 674. Back 674 of auxiliary frame 664 is proximate to the face of the person wearing auxiliary lens assembly 660. Front 672 faces away from the wearer. Auxiliary lenses 662 also have holes (not shown) that extend from front 672 to back 674.

Auxiliary lens assembly 660 further comprises an auxiliary bridge 664 to hold auxiliary lenses 662 in a fixed position relative to one another. In this particular configuration, auxiliary bridge 664 is secured directly to auxiliary lenses 662 without the use of a frame or rims wholly or partially encircling auxiliary lenses 662.

Auxiliary lens assembly 660 further comprises auxiliary extensions 666. As can best be seen in FIG. 31, auxiliary extensions 666 are attached to auxiliary lens assembly 660 through holes (not shown) in auxiliary lenses 662.

Each of auxiliary extensions 666 further comprises an auxiliary magnetic assembly 668. Auxiliary magnetic assembly 668 is formed at an end of one of auxiliary extensions 666. In one embodiment, auxiliary magnetic assembly 666 includes a micromagnet 140 embedded therein. In another embodiment, auxiliary magnetic assembly 668 employs a magnetically attractable material.

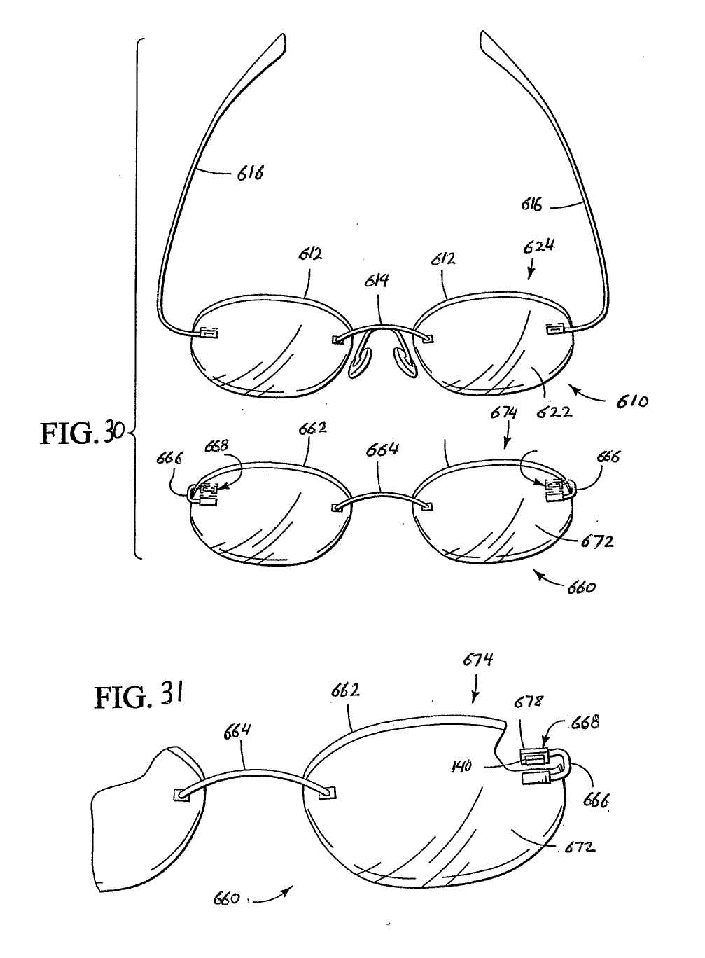

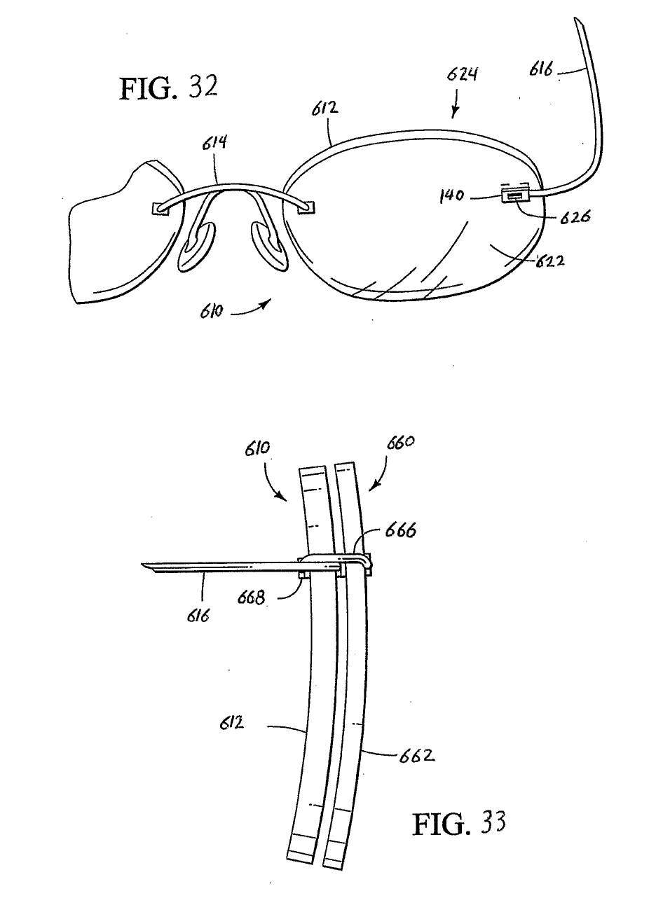

FIG. 32 illustrates a front view of primary lens assembly 610 in accordance with another embodiment of the present invention. As can be seen in FIG. 32, primary lens assembly 610 further comprises a bushing 626. Bushing 626 is located on back 624 of primary lens assembly 610. A micromagnet 140 is attached to the bushing 626. In another embodiment, micromagnet 140 is replaced with a magnetically attractable material.

As can be seen in FIGS. 30 and 31, when arms 616 are connected to primary lens assembly 610, pins 630 protrude through the holes (not shown) in primary lenses 612. Likewise, bushings 626 are located in the holes in primary lenses 612. Pins 630 are coupled to bushings 626 through the hollow centers of receptacles 644. In this configuration, barbs 632 of pins 630 securely engage the hollow centers of receptacles 644, securing arms 616 to front 622 of primary lenses 612, and securing bushings 626 to back 624 of primary lenses 612.

FIG. 33 is a side view of auxiliary lens assembly 660 attached to primary lens assembly 610. When primary lens assembly 610 and auxiliary lens assembly 660 are coupled, primary lenses 612 and auxiliary lenses 662 are in substantial alignment. In the embodiment illustrated, arm 616 mechanically supports auxiliary extension 666, and auxiliary magnetic assembly 668 is magnetically coupled to micromagnet 140 of bushing 626.

Along the end of arm 616 that terminates over front 622 of primary lens 612, supports are employed to secure the position of arms 616. Two or more pins 630 protrude from arm 616 in a direction of the face of the wearer. These pins 630 can have a variety of curvilinear or other shapes including, but not limited to cylindrical shapes.

Mechanical coupling force between arm 616 and bushing 626 is provided by barbs 632. When inserted into the hollow centers of receptacles 644, barbs 632 act to prevent disengagement of arms 616 from bushings 626. When bushing 626 mechanically engages pins 630, front surfaces 642 of bushings 626 are flush with back 624 of primary lens assembly 610.

Mounted to rear surface 642 of body 640 is micromagnet 140. Adhesives are commercially available and well known in the art for attaching conventional magnets to eyewear. The same adhesives are applicable for use with micromagnets 140.

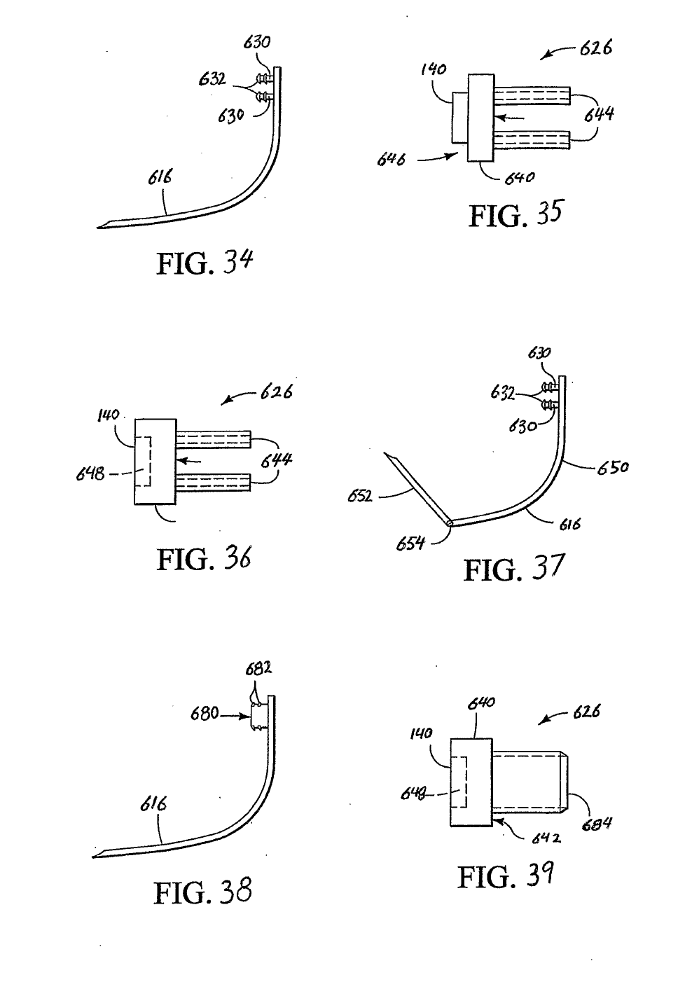

FIG. 34 is a top view of one of arms 616 in accordance with an embodiment of the present invention. Arms 616 are each typically a curved metal bar. At least one pin 630 is located at the end of each arm 616. In the embodiment shown, two pins 630 are located at an end of each arm 630. At least one barb 632 is located at on each of pins 630. In the embodiment shown, two barbs 632 are located on each pin 630.

FIG. 35 illustrates a top view of bushing 626. Bushing 626 comprises a body 640 having a front surface 642 and a rear surface 646. One or more receptacles 644 protrude from front surface 642. In the embodiment shown, receptacles 644 are hollow. One or more micromagnets 140 are mounted to rear surface 646 of body 640. Adhesives are commercially available and well known in the art for attaching magnets to plastic or metal surfaces, such as those commonly used in the eyewear industry. The same adhesives are applicable for use to attach micromagnets 140 to rear surface 646 of body 640.

In another embodiment of the present invention depicted is FIG. 36, a slot 648 is formed within body 640. Micromagnet 140 is located in slot 648. Micromagnet 140 may be adhesively attached within slot 648 or secured in interference fit. Alternatively, bushings 626 may be formed over micromagnets 140, creating slots 648. Additionally, in another embodiment of the present invention, micromagnet 140 can be replaced with a magnetically attractable material.

FIG. 37 discloses an alternative embodiment of arms 616, depicted in a top view. Each of arms 616 in this embodiment comprises a primary extension 650. Primary extension 650 has an end that terminates over front 622 of primary lens 612. Primary extension 650 has one or more pins 630. Pins 630 have barbs 632. Each of arms 616 further comprises a levered arm 652 and a pivot 654. Primary extension 650 couples to lever arm 652 at a pivot 654.

FIG. 38 discloses a top view of yet another embodiment of the present invention is depicted. In this embodiment, arms 616 employ a single pin 680. In this embodiment, pin 680 is preferably non-cylindrical. Barbs 682 are located on pin 680.

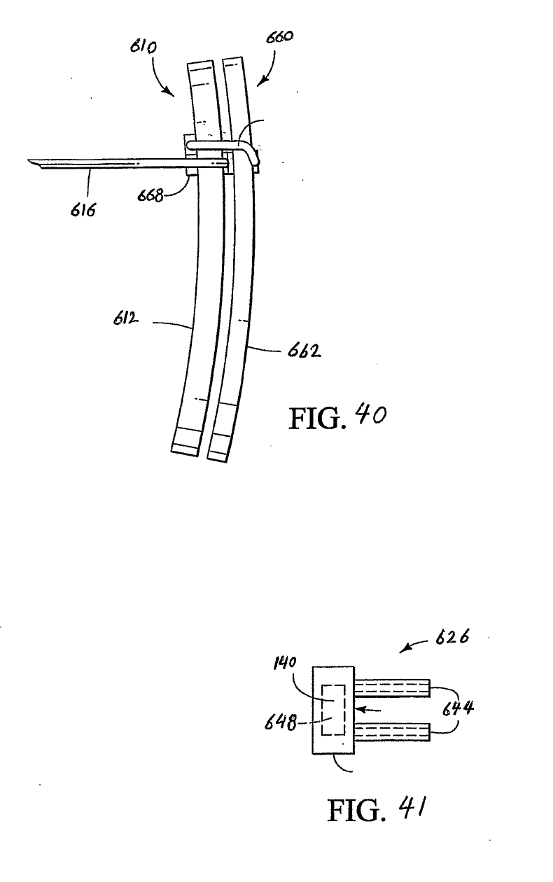

FIG. 39 discloses a bushing 626 in accordance for complementary connectivity with pin 680 (not shown). In this embodiment, bushing 626 comprises a body 640 having hollow receptacle 684, which protrudes from the body 640 to accommodate the pin 680. Bushing 626 of this embodiment as designed to be employed with a single support, such as pin 680. In order to couple with pin 680, receptacle 684 protrudes from rear surface 642 in a direction away from the face of the wearer through holes in primary lens assembly 610. In this embodiment, receptacle 684 is preferably non-cylindrical in shape to prevent rotation of arm 616 relative to primary lens 612

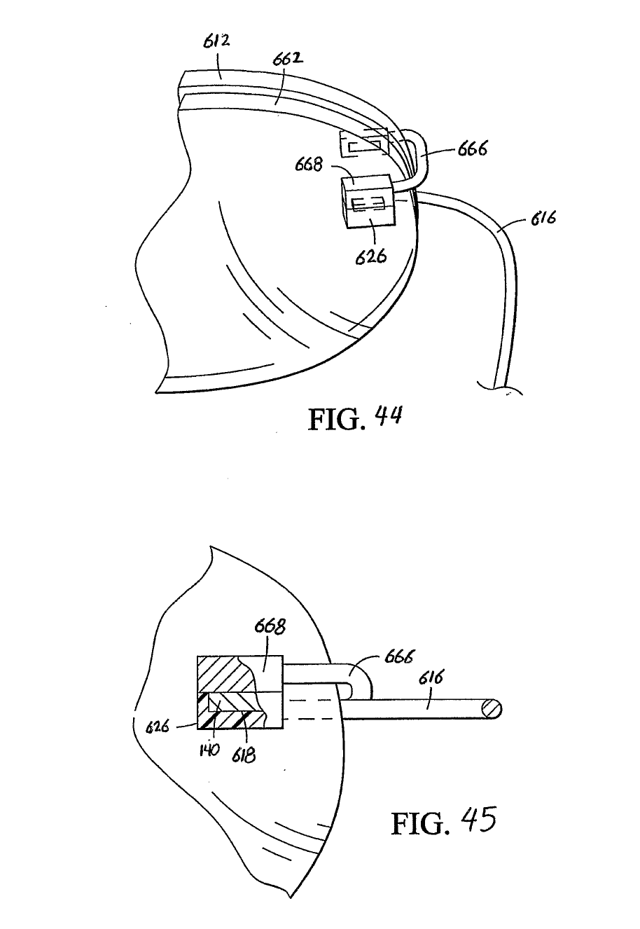

FIGS. 40 through 45 disclose an alternative embodiment of the attachment of auxiliary lens assembly 660 to primary lens assembly 610. In this embodiment, as best seen in FIGS. 40, 44, and 45, auxiliary magnetic assembly 668 rests in a position above bushing 626. A gap is provided between arm 616 and auxiliary extension 666 to prevent rubbing of externally visible surfaces. Thus, magnetic coupling forces and/or mechanical support forces maintain the position of auxiliary lens assembly 660 relative to primary lens assembly 610.

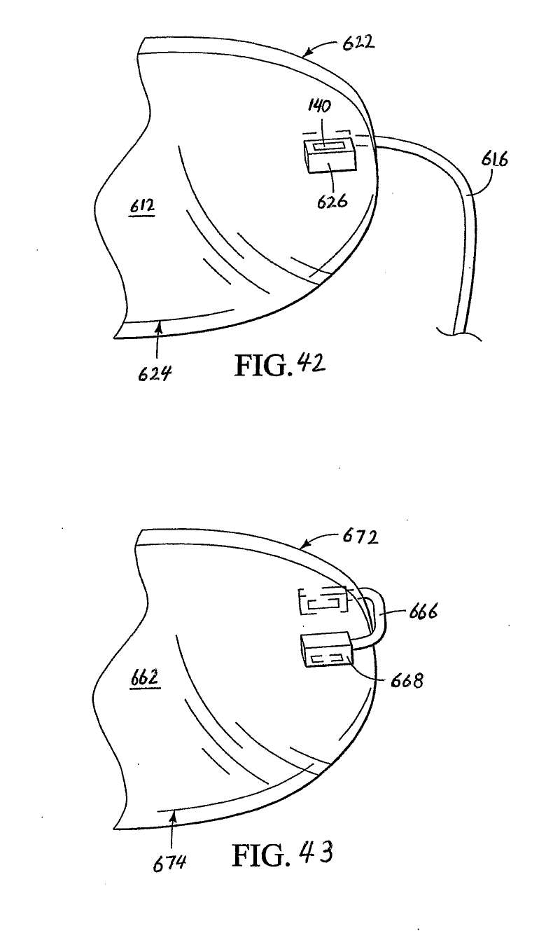

Now turning to FIG. 41, a top view of bushing 626 having an embedded micromagnet 140 in accordance with an embodiment of the present invention is shown. In this embodiment, slot 648 is formed in bushing 626. Micromagnet 140 is located in slot 648. Thus, as can best be seen in FIG. 42, bushing 626 can be oriented in a position where micromagnet 140 faces upward so as to be able to couple to auxiliary magnetic assembly 668 as seen in FIG. 43. However, slot 648 is formed in a side of the bushing 626 to accommodate micromagnet 140. In another embodiment of the present invention, micromagnet 140 can be replaced with a magnetically attractable material and a micromagnet 140 can be located in magnetic assembly 668.

As can best be seen in FIG. 42, bushing 626 can be oriented in a position where micromagnet 140 faces upward so as to be able to couple to magnetic assembly 668, shown in FIG. 43. In this manner, the mechanical engagement of bushings 626 and magnetic assembly 668 prevents downward movement of auxiliary lens assembly 660 relative to primary lens assembly 610, thus preserving the alignment of primary lenses 612 to auxiliary lenses 662.

In another embodiment, auxiliary extensions 666 of auxiliary lens assembly 660 can be removed. In this embodiment, auxiliary magnetic assembly 668 can be directly coupled to back 674 of auxiliary lens 662, in the same manner bushing 626 and micromagnet 140 are attached to primary lens assembly 610. Thus, when in use, magnetic forces between auxiliary magnetic assembly 668 and micromagnet 140 would maintain the position of auxiliary lens assembly 660 with respect to primary lens assembly 610.

Additionally, in other embodiments of the present invention, there are a number of varying configurations of auxiliary extensions 666. In these varying configurations, auxiliary extensions 666 can magnetically couple magnetically attractable material that comprises arms 616 or to micromagnets (not shown) embedded in arms 616.

In another embodiment of the present invention, auxiliary magnetic assembly 668 can be directly coupled to auxiliary bridge 664. Thus, when auxiliary lens assembly 660 engages primary lens assembly 610, auxiliary magnetic assembly 668 magnetically engages primary bridge 614.

Referring to FIGS. 40, 44, and 45, another configuration in accordance with another embodiment of the present invention can also be employed. In this particular configuration, magnetic assembly 668 rests on the upper surface of bushing 626. Thus, both the magnetic coupling force and/or and mechanical supporting forces between magnetic assembly 668 and bushing 626 maintain the position of the auxiliary lens assembly 660 relative to primary lens assembly 610 to assist in preventing disengagement when vertical separating forces are applied.

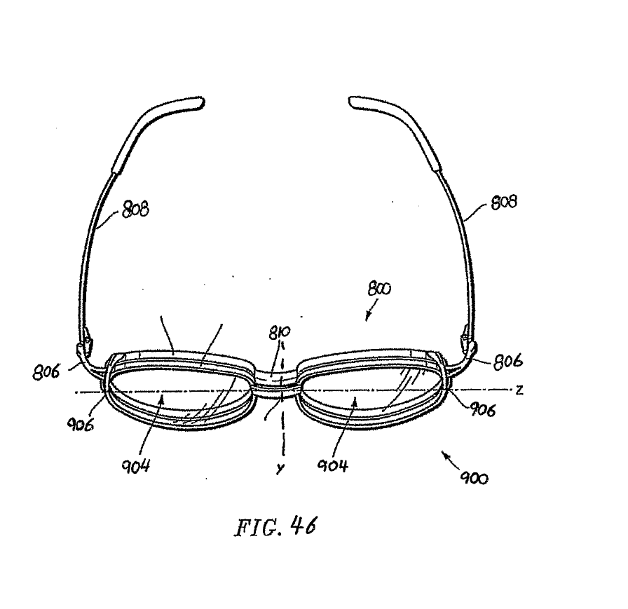

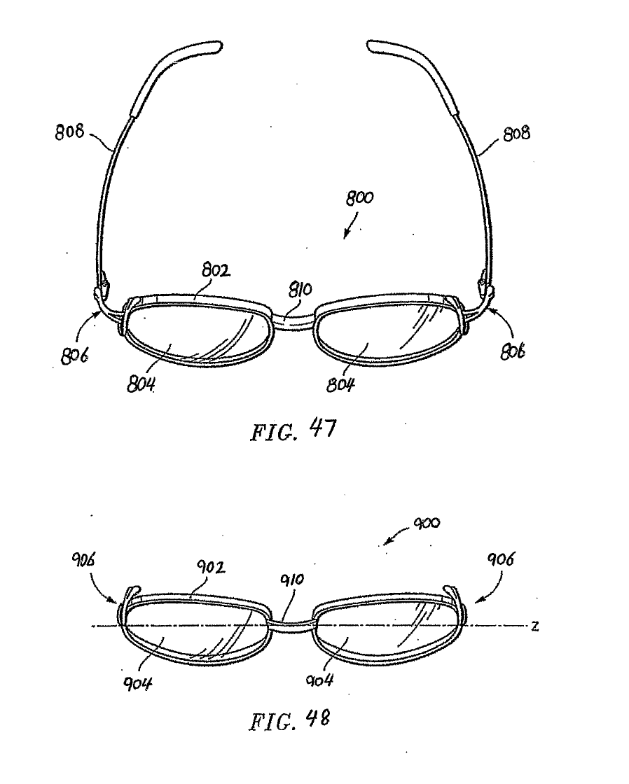

FIG. 46 is an isometric view in accordance with an embodiment of the present invention. In this view, a primary lens assembly 800 is coupled to an auxiliary lens assembly 900.

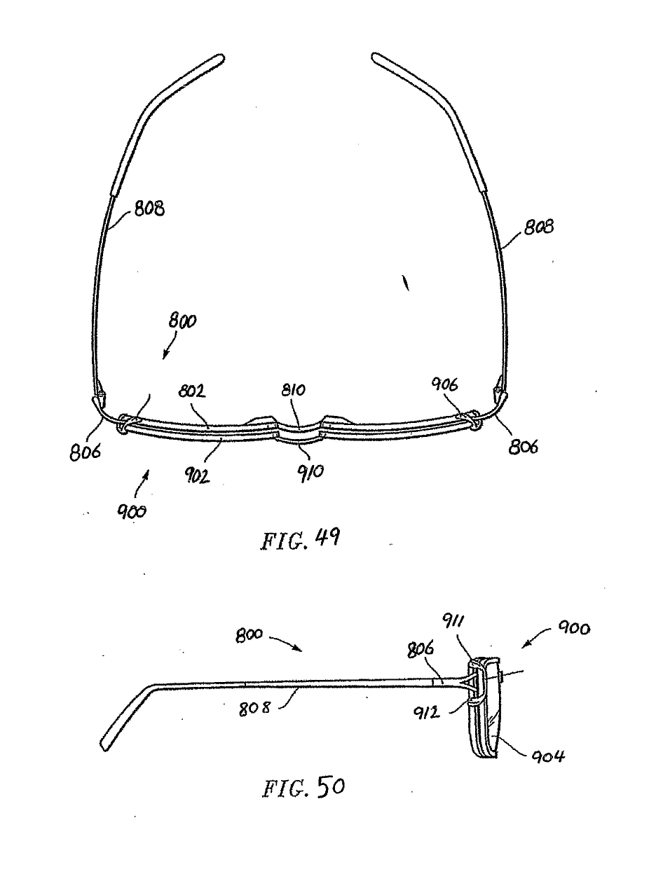

As can be seen in FIGS. 46, 47, 49, 50 and 54, primary lens assembly 800 comprises a primary frame 802, primary lenses 804, primary extensions 806, and arms 808. Primary lenses 804 are secured in fixed positions relative to one another by primary frame 802. Primary extensions 806 are affixed along the outer perimeter of primary frame 802, and arms 808 are pivotally affixed to primary extensions 806.

Primary frame 802 includes a primary bridge 810. Primary bridge 810 is located between primary lenses 804 and is responsible for securing the relative positions of primary lenses 804.

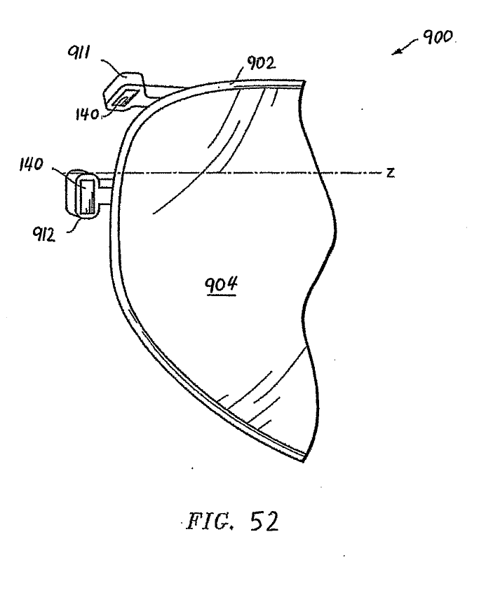

As depicted in FIGS. 46 and 50-55, auxiliary lens assembly 900 comprises an auxiliary frame 902, auxiliary lenses 904 and auxiliary extensions 906. Auxiliary frame 902 secures auxiliary lenses 904 in fixed positions relative to one another. When auxiliary lens assembly 900 is coupled to primary lens assembly 800, auxiliary lenses 904 are in substantial alignment with primary lenses 804. Auxiliary extensions 906 are affixed to the outer perimeter of auxiliary frame 902.

Auxiliary frame 902 also comprises an auxiliary bridge 910. Auxiliary bridge 910 is located between auxiliary lenses 904 and is responsible for securing auxiliary lenses 904 in fixed positions relative to one another.

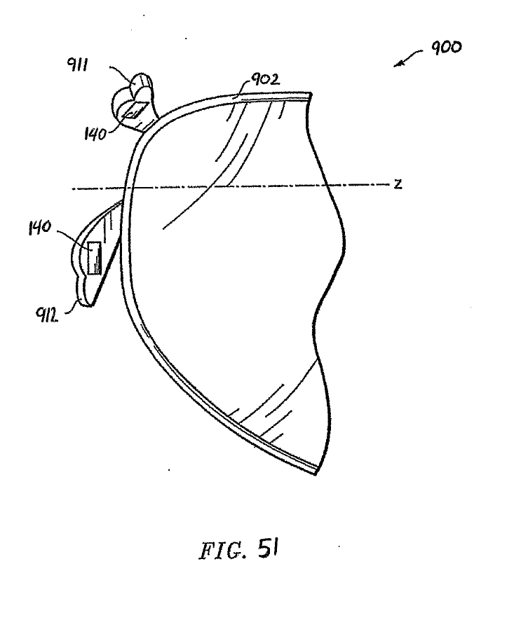

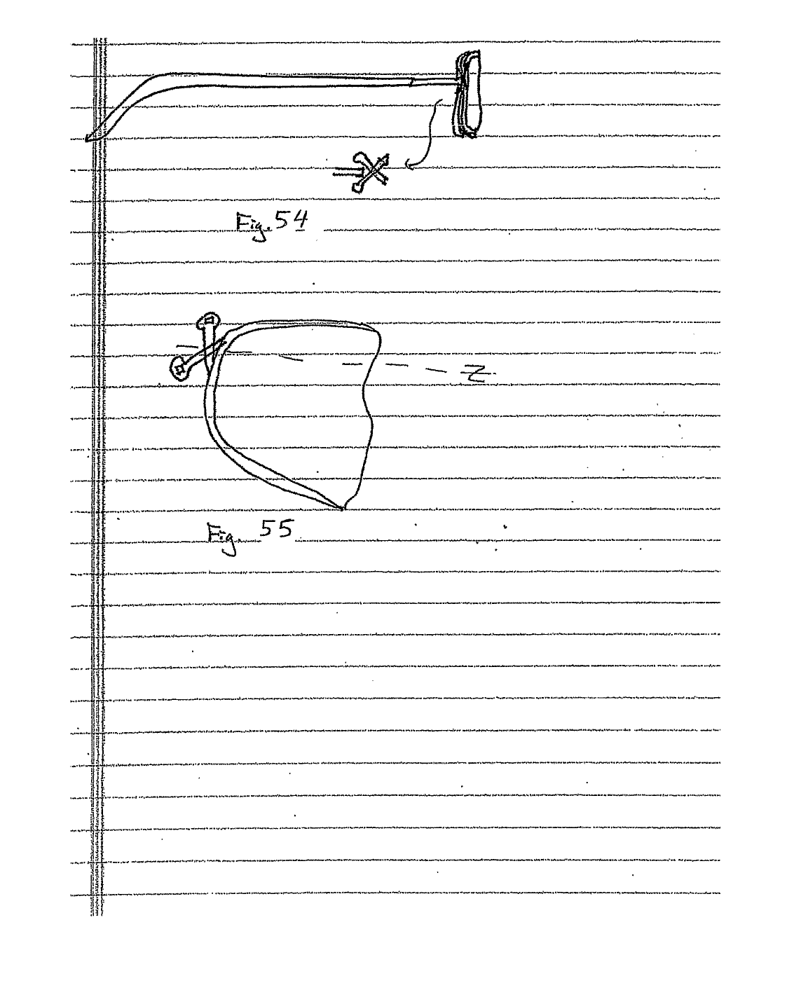

In FIGS. 50-55, auxiliary extensions 906 each further comprise an upper section 911 and a lower section 912. In the embodiment of the present invention depicted in FIGS. 50 and 51, upper section 911 and lower section 912 are formed from individual arms. In another alternative embodiment of the present invention as depicted in FIGS. 54 and 55, upper section 911 and lower section 912 are formed from individual arms but cross one another.

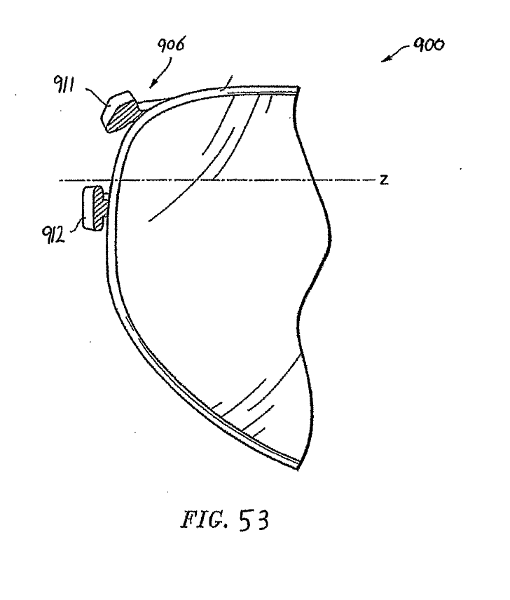

Additionally, in FIGS. 51, 52 and 55, micromagnets 140 are embedded in upper section 911 and lower section 912 so that auxiliary lens assembly 900 is capable of magnetically coupling to primary frame assembly 800. However, it is also possible to employ an interference fit with primary frame 802 instead of a magnetic coupling as can be seen with FIG. 53.

Referring to FIG. 46 through 55 of the drawings, the reference numeral 800 generally designates a primary lens assembly and the reference numeral 900 generally designates an auxiliary lens assembly.

Primary lens assembly 800 is commonly referred to as a pair of eyeglasses. Primary lens assembly 800 includes a pair of primary extensions 806 that extend from the periphery in direction toward the face of the wearer. Arms 808 are pivotally affixed to each of the primary extensions 806, such that arms 808 rest over the ears of the wearer.

In addition to having arms 808 support primary lens assembly 800, a primary bridge 810 is included that rests over the nose of the wearer. Primary bridge 810 not only provides support for primary frame 800 over the face of the wearer but also secures primary lenses 804 in fixed position relative to one another, generally over the eyes of the wearer while in use.

When desired, auxiliary lens assembly 900 can be coupled to primary lens assembly 800. When coupled, auxiliary lenses 904 are in substantial alignment with primary lenses 804. Alignment of auxiliary lenses 904 is as a result of auxiliary frame 902 that employs an auxiliary bridge 910 to secure auxiliary lenses in fixed positions relative to one another.

The coupling between auxiliary lens assembly 900 and primary lens assembly 800 is due to a magnetic coupling force or interference fit. Along the periphery of auxiliary frame 902 are auxiliary extensions 906. Each of the auxiliary extensions 906 has an upper portion 911 and a lower portion 912. In a situation where an interference fit is employed, upper portion 911 and lower portion 912 provide a frictional coupling to the primary frame 802. Alternatively, in a situation where magnetic coupling is employed, primary frame 802 are comprised of a magnetically attractable material, and upper portion 911 and lower portion 912 have micromagnets 140 embedded therein. Thus, micromagnets 920 magnetically couple to the primary frame 802.

Specifically, resistance to detachment of auxiliary lens assembly 900 from primary lens assembly 800 is not accomplished just by employing multiple contact points. Instead, strategic positioning of contact points enhances the stability of the auxiliary lens assembly. As can be seen in FIGS. 46 and 48, there are two distinct, orthogonal axes defined; horizontal axis (z) and vertical axis (y). Upper portion 911 and lower portion 912 are designed to straddle horizontal axis (z). With respect to straddling horizontal axis (z), it can be sent that horizontal axis (z) extends between the outer perimeters of auxiliary frame 902 where auxiliary extensions 906 are affixed.

As can be seen in FIGS. 50-55, upper portion 911 couples with primary frame 802 above this axis, and lower portion 912 couples with primary frame below this axis. By having a portion on each side of auxiliary frame 902 that couples above and below this axis, there are four distinct mating areas that will secure the positioning of auxiliary frame and provide increased resistance to decoupling when either vertical or horizontal separating forces are applied.

Moreover, each upper portion 911 and each lower portion are symmetrically positioned with each other relative to vertical axis (y). The combination of symmetry with respect to these orthogonal axes thus allows for a very stable mechanism for retaining the position of auxiliary lens assembly 900 when coupled to primary lens assembly 912.

Therefore, it can be seen that the present invention provides a number of benefits over more conventional designs. Specifically, because auxiliary extensions 906 straddle primary extensions 806, a wearer can easily couple auxiliary lens assembly 900 to primary lens assembly 800 with a single hand. Additionally, because auxiliary extensions 906 employ multiple mating areas, there is a decreased likelihood of decoupling when vertical and/or horizontal separating forces are applied.

The various embodiments disclosed herein which include magnetic attraction will be appreciated by one of ordinary skill in the art to involve a combination of micromagnet to micromagnet magnetic engagement, or magnet to magnetically attractable material magnetic engagement. It will be readily apparent to those skilled in the art, and the general principles defined herein may be applied to other embodiments and applications without departing from the spirit and scope of the present invention.

1. An eyewear system comprising:
a primary lens assembly;
an auxiliary lens assembly;
one or more pair of complementary mating areas disposed on said primary and auxiliary lens assemblies; and
each of said one or more pair of complementary mating areas including one or more micromagnets associated with a first complementary mating area and a magnetically attractable material associated with a second complementary mating area;
wherein said one or more micromagnets couple with said magnetically attractable material to removably affix said auxiliary lens assembly to said primary lens assembly.

2. The eyewear system of claim 1, wherein said one or more micromagnets are associated with a mating area of the auxiliary lens assembly.

3. The eyewear system of claim 1, wherein said one or more micromagnets are associated with a mating area of the primary lens assembly.

4. The eyewear system of claim 1, wherein there are at least two micromagnets positioned in a mating area in an end-to-end relationship wherein common poles of the micromagnets are adjacent to one another.

5. The eyewear system of claim 1, wherein said primary lens assembly comprises a frame portion comprising magnetically attractable material.

6. The eyewear system of claim 1, wherein said auxiliary lens assembly comprises a frame portion comprising magnetically attractable material.

7. The eyewear system of claim 1, wherein said primary lens assembly comprises a molded frame made of a non-magnetically attractable material.

8. The eyewear system of claim 1, wherein said primary lens assembly is frameless.

9. The eyewear system of claim 1, wherein said auxiliary lens assembly is frameless.

10. The eyewear system of claim 1, wherein one or more shelves extend rearward from the auxiliary lens assembly for housing said one or more micromagnets.

11. The eyewear system of claim 1 wherein the one or more micromagnets are electroplated.

12. A process of manufacturing an eyewear system comprising the steps of:
affixing micromagnetic material to a mating area of an auxiliary lens assembly or a primary lens assembly; and
magnetizing said micromagnetic material to provide one or more micromagnets.

13. The process according to claim 12 wherein the micromagnetic material is covered with a layer of epoxy before magnetization.

14. An eyewear system comprising: a primary lens assembly comprising one or more primary lens mating areas; an auxiliary lens assembly comprising one or more auxiliary lens mating areas configured to align with said one or more primary lens mating areas; one or more micromagnets associated with one or more of said one or more mating areas; and a magnetically attractable material associated with one or more of said one or more mating areas and capable of coupling with said one or more micromagnets, wherein said one or more micromagnets couple with said magnetically attractable material when said one or more auxiliary lens mating areas are in sufficient proximity and alignment with said one or more primary lens mating areas.

15. An auxiliary lens assembly comprising one or more micromagnets for coupling with a magnetically attractable material of a primary lens assembly.
